(19) United States
(12) Patent Application Publication
(10) Pub. No.: US 2026/0222834 A1
(43) Pub. Date: Jul. 30, 2026

(54) REPORTING PERFORMANCE MONITORING RESULTS

(71) Applicant: Lenovo (United States) Inc., Morrisville, NC (US)

(72) Inventors: Robin Rajan Thomas, Bad Nauheim (DE); Vahid Pourahmadi, München (DE)

(21) Appl. No.: 19/041,851

(22) Filed: Jan. 30, 2025

(51) Int. Cl. H04W 24/02

(52) U.S. Cl. CPC H04W 24/02

(57) ABSTRACT

Various aspects of the present disclosure relate to determining a reporting configuration for model performance monitoring, wherein the reporting configuration comprises a set of parameters identifying one or more performance indicators associated with one or more artificial intelligence or machine learning (AI/ML) models; transmitting a request message for one or more model performance monitoring results, wherein the request message comprises the reporting configuration; and receiving a response message comprising one or more model performance monitoring results.

### TECHNICAL FIELD

The present disclosure relates to wireless communications, and more specifically to techniques for reporting performance monitoring results, for example performance indicators associated with one or more artificial intelligence or machine learning (AI/ML) models.

### BACKGROUND

A wireless communications system may include one or multiple network communication devices, which may be known as a network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like). Additionally, the wireless communications system may support wireless communications across various radio access technologies (RATs) including third generation (3G) radio access technology, fourth generation (4G) radio access technology, fifth generation (5G) radio access technology, among other suitable radio access technologies beyond 5G (e.g., 5G-Advanced (5G-A), sixth generation (6G), etc.).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A UE for wireless communication is described. The UE may be configured to, capable of, or operable to receive a request message for reporting one or more model performance monitoring results, wherein the request message comprises a reporting configuration including a set of parameters identifying one or more performance indicators associated with one or more AI/ML models; determine one or more model performance metrics associated with the one or more AI/ML models; convert the one or more performance model metrics to a set of model performance monitoring results based at least in part on the reporting configuration; and transmit a response message comprising the set of set of model performance monitoring results.

A processor for wireless communication is described. The processor may be configured to, capable of, or operable to receive a request message for reporting one or more model performance monitoring results, wherein the request message comprises a reporting configuration including a set of parameters identifying one or more performance indicators associated with one or more AI/ML models; determine one or more model performance metrics associated with the one or more AI/ML models; convert the one or more performance model metrics to a set of model performance monitoring results based at least in part on the reporting configuration; and transmit a response message comprising the set of set of model performance monitoring results.

A method performed or performable by a UE for wireless communication is described. The method may include receiving a request message for reporting one or more model performance monitoring results, wherein the request message comprises a reporting configuration including a set of parameters identifying one or more performance indicators associated with one or more AI/ML models; determining one or more model performance metrics associated with the one or more AI/ML models; converting the one or more performance model metrics to a set of model performance monitoring results based at least in part on the reporting configuration; and transmitting a response message comprising the set of set of model performance monitoring results.

A base station for wireless communication is described. The base station may be configured to, capable of, or operable to receive a request message for reporting one or more model performance monitoring results, wherein the request message comprises a reporting configuration including a set of parameters identifying one or more performance indicators associated with one or more AI/ML models; determine one or more model performance metrics associated with the one or more AI/ML models; convert the one or more performance model metrics to a set of model performance monitoring results based at least in part on the reporting configuration; and transmit a response message comprising the set of set of model performance monitoring results.

A method performed or performable by a base station for wireless communication is described. The method may include receiving a request message for reporting one or more model performance monitoring results, wherein the request message comprises a reporting configuration including a set of parameters identifying one or more performance indicators associated with one or more AI/ML models; determining one or more model performance metrics associated with the one or more AI/ML models; converting the one or more performance model metrics to a set of model performance monitoring results based at least in part on the reporting configuration; and transmitting a response message comprising the set of set of model performance monitoring results.

A network node for performance monitoring is described. The base station may be configured to, capable of, or operable to determine a reporting configuration for model performance monitoring, wherein the reporting configuration comprises a set of parameters identifying one or more performance indicators associated with one or more AI/ML models; transmit a request message for one or more model performance monitoring results, wherein the request message comprises the reporting configuration; and receive a response message comprising one or more model performance monitoring results.

A processor for performance monitoring is described. The processor may be configured to, capable of, or operable to determine a reporting configuration for model performance monitoring, wherein the reporting configuration comprises a set of parameters identifying one or more performance indicators associated with one or more AI/ML models; transmit a request message for one or more model performance monitoring results, wherein the request message comprises the reporting configuration; and receive a response message comprising one or more model performance monitoring results.

A method performed or performable by a network node for performance monitoring is described. The method may include determining a reporting configuration for model performance monitoring, wherein the reporting configuration comprises a set of parameters identifying one or more performance indicators associated with one or more AI/ML models; transmitting a request message for one or more model performance monitoring results, wherein the request message comprises the reporting configuration; and receiving a response message comprising one or more model performance monitoring results.

### BRIEF DESCRIPTION OF THE DRAWINGS

FIG. 1 illustrates an example of a wireless communications system in accordance with aspects of the present disclosure.

FIG. 2 illustrates an example of a protocol stack, in accordance with aspects of the present disclosure.

FIG. 3 illustrates an example of a downlink (DL) based positioning, in accordance with aspects of the present disclosure.

FIG. 4 illustrates an example of a functional framework for AI/ML for an air interface, in accordance with aspects of the present disclosure.

FIG. 5 illustrates an example of a functional framework for AI/ML for an air interface, in accordance with aspects of the present disclosure.

FIG. 6 illustrates an example of a procedure for reporting performance monitoring results, in accordance with aspects of the present disclosure.

FIG. 7 illustrates an example of a procedure for reporting performance monitoring results, in accordance with aspects of the present disclosure.

FIG. 8 illustrates an example of a procedure for requesting assistance information or configuration information, in accordance with aspects of the present disclosure.

FIG. 9 illustrates an example of a procedure for requesting assistance information or configuration information, in accordance with aspects of the present disclosure.

FIG. 10 illustrates an example of a UE, in accordance with aspects of the present disclosure.

FIG. 11 illustrates an example of a processor, in accordance with aspects of the present disclosure.

FIG. 12 illustrates an example of a NE, in accordance with aspects of the present disclosure.

FIG. 13 illustrates a flowchart of a method performed by a UE or a NE, in accordance with aspects of the present disclosure.

FIG. 14 illustrates a flowchart of a method performed by a network node, in accordance with aspects of the present disclosure.

### DETAILED DESCRIPTION

Wireless communications systems including and beyond 5G systems may implement AI/ML positioning to improve the location estimate accuracy of a device (e.g., UE) particularly in challenging radio conditions, such as environments with heavy non-line-of-sight (NLOS) conditions. One example of AI/ML positioning is the direct AI/ML positioning, where the output of the AI/ML model is a user's location (e.g., UE's position). Another example of AI/ML positioning is the assisted AI/ML positioning, where the output is an enhanced positioning measurement with associated information such as an enhanced line-of-sight (LOS) or NLOS (LOS/NLOS) classification of the measurement as an output of the AI/ML model.

T0 facilitate life cycle management (LCM) operations specific to direct AI/ML positioning and assisted AI/ML positioning, AI/ML functionality-based LCM framework may be implemented to enable the activation or deactivation (and/or the fallback or switching) of various AI/ML functionality via 3rd Generation Partnership Project (3GPP) procedures including specified 3GPP signaling and messages. In certain embodiments, an AI/ML model may be trained on one or more functionalities, which may depend on the combination of information provided by the UE and/or network, e.g., base station. In other embodiments, multiple AI/ML models may be trained on a certain functionality.

Moreover, one or more LCM procedures may include the capability for a network entity or the target device (e.g. UE or NG-RAN node) to perform near real-time monitoring of its own model(s) and share some aspects, e.g., monitoring outcome with other entities/nodes. Additionally, the network entity or the target device (e.g. UE or NG-RAN node) may retrieve assistance information or one or more input parameters, e.g., ground truth information in order to help with its own performance model monitoring calculation. Other examples of LCM procedures include the updating of an AI/ML model, the switching of an AI/ML model, the activation of an AI/ML model, the deactivation of an AI/ML model, the training of an AI/ML model, AI/ML model inference, AI/ML model transfer, and so forth.

However, the manner in which a NE (e.g., base station or next generation radio access network (NG-RAN) node) or UE (or other wireless communication device) computes a model monitoring metric may not be specified, e.g., to provide flexibility in such a manner where one or more model performance metrics can be calculated by the NE or the UE according to its own implementation. Moreover, there is no existing procedural framework in which to support the trigger, request and reporting of such metrics.

Although the monitoring metric calculation may be up to implementation, it may be expected or beneficial for the NE or UE performing the metric calculation to share the monitoring outcome with another entity, such as another NE or UE, or a core network (CN) involved with the model implementation, where the monitoring outcome is interpretable in a standardized manner among the different network entities or UE.

The present disclosure aims to address the aforementioned issues in order to enhance AI/ML model functionality-based LCM procedures, especially with respect to model monitoring outcome or monitoring result indication. Various embodiments are described to cover different AI/ML model performance monitoring and reporting scenarios.

Aspects of the present disclosure describe a framework to support the retrieval of performance monitoring outcome/results associated to one or more AI/ML models. In some example, the AI/ML models may be used for positioning by a network entity, e.g., a network data analytics function (NWDAF), a location management function (LMF), or a location services (LCS) server. In some examples, the monitoring outcome/results may be indicated to a different network entity/node.

A first solution describes a framework for reporting performance monitoring outcome/results by a UE to a network entity (e.g., LCS server, location server, LMF, NWDAF). Beneficially, the reporting framework enables the network entity to become aware if the AI/ML model hosted in the UE performs well or requires any further network configuration adaptation, e.g., for the inference configuration. The reporting framework defines requests and responses to enable efficient transfer of the performance model monitoring outcomes/results associated with multiple AI/ML models and/or AI/ML functionalities.

A second solution describes a framework for reporting performance monitoring outcome/results by an NG-RAN node (e.g., gNB) to a network entity (e.g., LCS server, location server, LMF, NWDAF). Beneficially, the reporting framework enables the network entity to become aware if the AI/ML model hosted in the NG-RAN (e.g., gNB) performs well or requires any further network configuration adaptation, e.g., for the inference configuration, modify the DL-PRS configuration used for training and inference. The reporting framework defines requests and responses to enable efficient transfer of the performance model monitoring outcomes/results associated with multiple AI/ML models and/or AI/ML functionalities.

A third solution describes techniques and contents of performance monitoring outcome request messages to enable the transfer of the performance model monitoring outcomes/results. Furthermore, the network entity (e.g., LCS server, location server, LMF, NWDAF) may include desired performance requirements, scheduled performance monitoring results/outcomes at a future time instance or time domain model/functionality performance outcome/result reporting criteria.

A fourth solution describes techniques and contents of performance monitoring outcome response messages to enable the transfer of the performance model monitoring outcomes/results. This solution addresses content features associated with the performance outcome/result report. Beneficially, meta-information associated with the performance monitoring outcome/results enables meaningful interpretation of the received outcome/results.

A fifth solution describes techniques and procedures for requesting assistance data from a network entity related to the computation of the AI/ML monitoring metrics. Beneficially, the UE or NG-RAN node (e.g., gNB) may receive configuration information to aid in calculating performance monitoring outcome/results.

While presented as distinct solutions, one or more of the solutions described herein may be implemented in combination with each other. Aspects of the present disclosure are described in the context of a wireless communications system.

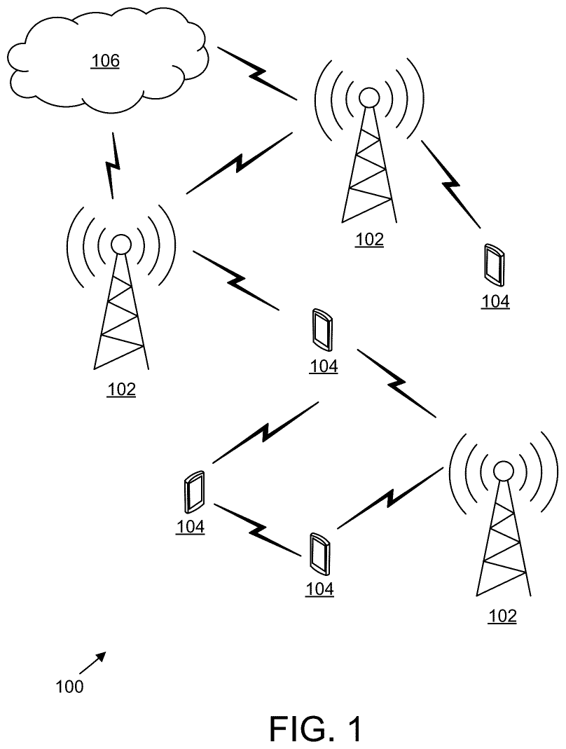

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies (RATs). In some implementations, the wireless communications system 100 may be a 4G network, such as a long-term evolution (LTE) network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a wireless communication network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an internet-of-things (IoT) device, an internet-of-everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing (SCS) value and a cyclic prefix. A first numerology (e.g., μ=0) may be associated with a first SCS value (e.g., 15 kHz) and a normal cyclic prefix. In some implementations, the first numerology (e.g., μ=0) associated with the first SCS value (e.g., 15 kHz) may utilize one slot per subframe. A second numerology (e.g., μ=1) may be associated with a second SCS value (e.g., 30 kHz) and a normal cyclic prefix. A third numerology (e.g., μ=2) may be associated with a third SCS value (e.g., 60 kHz) and a normal cyclic prefix or an extended cyclic prefix. A fourth numerology (e.g., μ=³) may be associated with a fourth SCS value (e.g., 120 kHz) and a normal cyclic prefix. A fifth numerology (e.g., μ=⁴) may be associated with a fifth SCS value (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective SCS values of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz SCS), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first SCS value (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations frequency range #1 (FR1) (e.g., 410 MHz-7.125 GHz), frequency range #2 (FR2) (e.g., 24.25 GHz-52.6 GHz), frequency range #3 (FR3) (e.g., 7.125 GHz-24.25 GHz), frequency range #4 (FR4) (e.g., 52.6 GHz-114.25 GHz), frequency range #4a (FR4a) or frequency range #4-1 (FR4-1) (e.g., 52.6 GHz-71 GHz), and frequency range #5 (FR5) (e.g., 114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz SCS; a second numerology (e.g., μ=1), which includes 30 kHz SCS; and a third numerology (e.g., μ=2), which includes 60 kHz SCS. FR2 may be associated with one or multiple numerologies (e.g., at least 2 numerologies). For example, FR2 may be associated with a third numerology (e.g., μ=2), which includes 60 kHz SCS; and a fourth numerology (e.g., μ=3), which includes 120 kHz SCS.

According to implementations, one or more of the NEs 102 and the UEs 104 are operable to implement various aspects of the techniques described with reference to the present disclosure.

In some implementations, a network entity in the CN 106 may transmit a request message to a NE 102 for reporting an AI/ML model/functionality performance outcome/result. The request message may include desired performance requirements. In some examples, the request message may also schedule performance monitoring results/outcomes at a future time instance. In some examples, the request message may define reporting criteria for performance monitoring results/outcomes associated with an AI/ML model and/or AI/ML functionality.

Upon receiving the request message, the NE 102 derives the performance monitoring results/outcomes in accordance with the request message and transmits a response message containing the performance monitoring results/outcomes and, optionally, additional associated information. In some examples, the NE 102 may map one or more performance model monitoring metrics to the performance monitoring results/outcomes and, optionally, the additional associated information.

In some implementations, a network entity in the CN 106 may transmit a request message to a UE 104 for reporting an AI/ML model/functionality performance outcome/result. The request message may include desired performance requirements. In some examples, the request message may also schedule performance monitoring results/outcomes at a future time instance. In some example, the request message may define reporting criteria for performance monitoring results/outcomes associated with an AI/ML model and/or AI/ML functionality.

Upon receiving the request message, the U n 104 derives the performance monitoring results/outcomes in accordance with the request message and transmits a response message containing the performance monitoring results/outcomes and, optionally, additional associated information. In some examples, the U(104 may map one or more performance model monitoring metrics to the performance monitoring results/outcomes and, optionally, the additional associated information.

In some examples, the NE 102 and/or UE 104 may transmit a request for assistance data and/or configuration information to the network entity (e.g., in the CN 106). The request may also additionally include some associated meta-information regarding the type of assistance data and/or configuration information.

The supported positioning techniques in Rel-16 are listed in Table 1, below. These techniques are defined in 3GPP Technical Specification (TS) 38.305.

TABLE 1
Supported Rel-16 UE positioning methods

| | | UE- | | |
|---|---|---|---|---|
| | | assisted, | NG-RAN | Secure User- |
| | UE- | LMF- | node | Plane |
| Method | based | based | assisted | Location (SUPL) |
| Assisted GNSS | Yes | Yes | No | Yes (UE-based and |
| | | | | UE-assisted) |
| OTDOA ^{Note1, Note 2} | No | Yes | No | Yes (UE-assisted) |
| E-CID ^{Note 3} | No | Yes | Yes | Yes, for E-UTRA |
| | | | | (UE-assisted) |
| Sensor | Yes | Yes | No | No |
| WLAN | Yes | Yes | No | Yes |
| BLUETOOTH | No | Yes | No | No |
| TBS ^{Note 4} | Yes | Yes | No | Yes (MBS) |
| DL-TDOA | Yes | Yes | No | No |
| DL-AoD | Yes | Yes | No | No |
| Multi-RTT | No | Yes | Yes | No |
| NR E-CID | No | Yes | — | No |
| UL-TDOA | No | No | Yes | No |
| UL-AoA | No | No | Yes | No |

^{Note1}:
This includes terrestrial beacon system (TBS) positioning based on positioning reference signals (PRS).
^{Note 2}:
In this version of the specification only observed time difference of arrival (OTDOA) based on LTE signals is supported.
^{Note 3}:
This includes cell identifier (Cell-ID) for NR method.
^{Note 4}:
In this version of the specification only for TBS positioning based on metropolitan beacon system (MBS) signals.

Separate positioning techniques as indicated in Table 1 can currently be configured and performed based on the requirements of the LMF and UE capabilities. The transmission of at least one PRS enables the UE 206 to perform UE positioning-related measurements to enable the computation of a UE's location estimate and are configured per TRP, where a TRP may transmit one or more beams.

The following RAT-dependent positioning techniques are supported in 3GPP Rel-16: DL time difference of arrival (DL-TDOA); DL angle-of-departure (DL-AoD); multiple-cell round trip time (Multi-RTT); enhanced cell identity (E-CID); uplink (UL) time difference of arrival (UL-TDOA); UL angle-of-arrival (UL-AoA).

The DL-TDOA positioning method makes use of the DL reference signal time difference (RSTD) (and optionally DL positioning reference signal (PRS) reference signal received power (RSRP)) of DL signals received from multiple transmission points (TPs), at the UE 206. The UE 206 measures the DL RSTD (and optionally DL PRS RSRP) of the received signals using assistance data received from the positioning server, and the resulting measurements are used along with other configuration information to locate the UE 206 in relation to the neighboring TPs.

The DL-AoD positioning method makes use of the measured DL PRS RSRP of DL signals received from multiple TPs, at the UE 206. The UE 206 measures the DL PRS RSRP of the received signals using assistance data received from the positioning server, and the resulting measurements are used along with other configuration information to locate the UE 206 in relation to the neighboring TPs.

The Multi-RTT positioning method makes use of the UE reception-to-transmission (Rx-Tx) measurements and DL PRS RSRP of DL signals received from multiple TRPs, measured by the UE 206 and the measured gNB Rx-Tx measurements and UL sounding reference signal RSRP (UL SRS-RSRP) at multiple TRPs of UL signals transmitted from UE 206.

According to an exemplary Multi-RTT procedure, the UE 206 measures the UE Rx-Tx measurements (and optionally DL PRS RSRP of the received signals) using assistance data received from the positioning server, and the TRPs measure the gNB Rx-Tx measurements (and optionally UL SRS-RSRP of the received signals) using assistance data received from the positioning server. The measurements are used to determine the round trip time (RTT) at the positioning server which are used to estimate the location of the UE 206.

In the E-CID positioning method, the position of a UE 206 is estimated with the knowledge of its serving next-generation eNB (ng-eNB), gNB and cell, and is based on Uu (e.g., LTE) signals. The information about the serving ng-eNB, gNB and cell may be obtained by paging, registration, or other methods. The NR E-CID positioning method refers to techniques which use additional UE measurements and/or NR radio resource and other measurements to improve the UE location estimate using NR signals.

Although the NR E-CID positioning method may utilize some of the same measurements as the measurement control system in the RRC protocol, the UE 206 generally is not expected to make additional measurements for the sole purpose of positioning; i.e., the positioning procedures do not supply a measurement configuration or measurement control message, and the UE 206 reports the measurements that it has available rather than being required to take additional measurement actions.

The UL-TDOA positioning method makes use of the time difference of arrival (and optionally UL SRS-RSRP) at multiple reception points (RPs) of UL signals transmitted from UE 206. The RPs measure the UL TDOA (and optionally UL SRS-RSRP) of the received UL signals using assistance data received from the positioning server, and the resulting measurements are used along with other configuration information to estimate the location of the UE 206.

The UL-AoA positioning method makes use of the measured azimuth and the zenith of arrival at multiple RPs of UL signals transmitted from UE 206. The RPs measure azimuth angle-of-arrival (A-AoA) and/or zenith angle-of-arrival (Z-AoA) of the received signals using assistance data received from the positioning server, and the resulting measurements are used along with other configuration information to estimate the location of the UE 206.

RAT-dependent positioning techniques involve the 3GPP RAT and core network entities to perform the position estimation of the UE 206, which are differentiated from RAT-independent positioning techniques which rely on global navigation satellite system (GNSS), inertial measurement unit (IMU) sensor, wireless local area network (WLAN) and/or BLUETOOTH technologies for performing target device (i.e., UE 206) positioning.

The following RAT-independent positioning techniques are supported in Rel-16: network-assisted GNSS, barometric pressure sensor positioning, WLAN positioning, BLUETOOTH positioning, TBS positioning, motion sensor positioning.

The network-assisted GNSS methods make use of UEs 206 that are equipped with radio receivers capable of receiving GNSS signals. In 3GPP specifications the term GNSS encompasses both global and regional/augmentation navigation satellite systems.

Examples of global navigation satellite systems include Global Positioning System (GPS), Modernized GPS, Galileo, GLObal'naya NAvigatsionnaya Sputnikovaya Sistema (GLONASS), and BeiDou Navigation Satellite System (BDS). Regional navigation satellite systems include the Quasi Zenith Satellite System (QZSS) while the many augmentation systems, are classified under the generic term of space based augmentation systems (SBAS) and provide regional augmentation services. In this concept, different GNSSs (e.g., GPS, Galileo, etc.) can be used separately or in combination to determine the location of a UE 206.

Regarding barometric pressure sensor positioning, the barometric pressure sensor method makes use of barometric sensors to determine the vertical component of the position of the UE 206. The UE 206 measures barometric pressure, optionally aided by assistance data, to calculate the vertical component of its location or to send measurements to the positioning server for position calculation. This method should be combined with other positioning methods to determine the 3D position of the UE 206.

Regarding WLAN positioning, the WLAN positioning method makes use of the WLAN measurements (e.g., WLAN access point (AP) identifiers and, optionally, signal strength or other measurements) and databases to determine the location of the UE 206. The UE 206 measures received signals from WLAN APs, optionally aided by assistance data, to send measurements to the positioning server for position calculation. Using the measurement results and a references database, the location of the UE 206 is calculated. Alternatively, the UE 206 makes use of WLAN measurements and optionally WLAN AP assistance data provided by the positioning server, to determine its location.

Regarding BLUETOOTH positioning, the BLUETOOTH positioning method makes use of BLUETOOTH measurements (beacon identifiers and optionally other measurements) to determine the location of the UE 206. The UE 206 measures received signals from BLUETOOTH beacons. Using the measurement results and a references database, the location of the UE 206 is calculated. The BLUETOOTH methods may be combined with other positioning methods (e.g., WLAN) to improve positioning accuracy of the UE 206.

A TBS consists of a network of ground-based transmitters, broadcasting signals only for positioning purposes. Regarding TBS positioning, the current type of TBS positioning signals are the metropolitan beacon system (MBS) signals and PRS. The UE 206 measures received TBS signals, optionally aided by assistance data, to calculate its location or to send measurements to the positioning server for position calculation.

Regarding IMU/motion sensor positioning, this method makes use of different sensors such as accelerometers, gyros, magnetometers, to calculate the displacement of the UE 206. The UE 206 estimates a relative displacement based upon a reference position and/or reference time. The UE 206 sends a report comprising the determined relative displacement which can be used to determine the absolute position. This method should be used with other positioning methods for hybrid positioning.

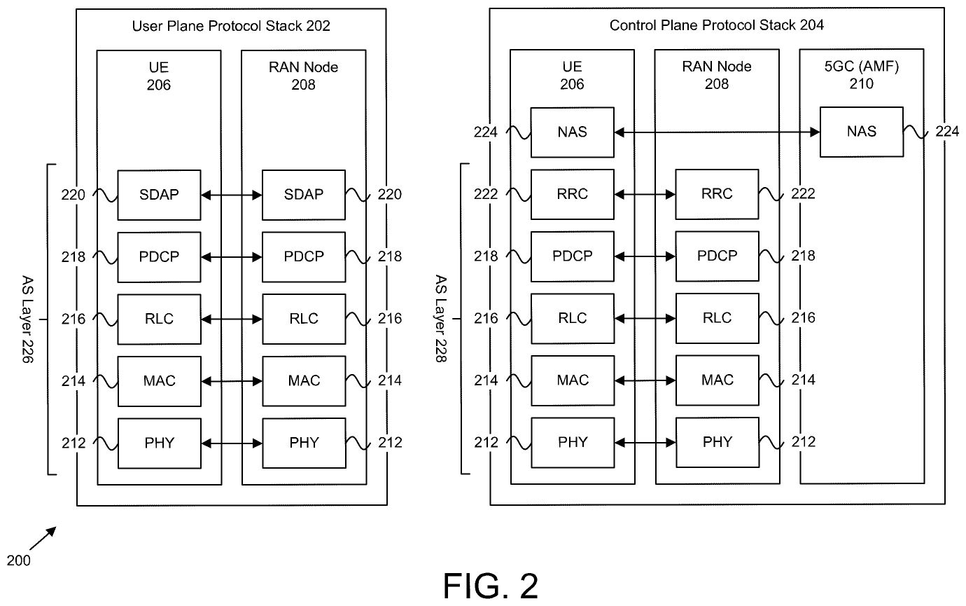

FIG. 2 illustrates an example of a protocol stack 200, in accordance with aspects of the present disclosure. While FIG. 2 shows a UE 206, a RAN node 208, and a 5GC 210 (e.g., comprising at least an AMF), these are representative of a set of UEs 104 interacting with an NE 102 (e.g., base station) and a CN 106. As depicted, the protocol stack 200 comprises a user plane protocol stack 202 and a control plane protocol stack 204. The user plane protocol stack 202 includes a PHY layer 212, a MAC sublayer 214, a radio link control (RLC) sublayer 216, a packet data convergence protocol (PDCP) sublayer 218, and a service data adaptation protocol (SDAP) sublayer 220. The control plane protocol stack 204 includes a PHY layer 212, a MAC sublayer 214, a RLC sublayer 216, and a PDCP sublayer 218. The Control Plane protocol stack 204 also includes a radio resource control (RRC) layer 222 and a non-access stratum (NAS) layer 224.

The AS layer 226 (also referred to as “AS protocol stack”) for the user plane protocol stack 202 consists of at least SDAP, PDCP, RLC and MAC sublayers, and the physical layer. The AS layer 228 for the control plane protocol stack 204 consists of at least RRC, PDCP, RLC and MAC sublayers, and the physical layer. The layer-1 (L1) includes the PHY layer 212. The layer-2 (L2) is split into the SDAP sublayer 220, PDCP sublayer 218, RLC sublayer 216, and MAC sublayer 214. The layer-3 (L3) includes the RRC layer 222 and the NAS layer 224 for the control plane and includes, e.g., an internet protocol (IP) layer and/or PDU Layer (not depicted) for the user plane. L1 and L2 are referred to as “lower layers,” while L3 and above (e.g., transport layer, application layer) are referred to as “higher layers” or “upper layers.”

The PHY layer 212 offers transport channels to the MAC sublayer 214. The PHY layer 212 may perform a beam failure detection procedure using energy detection thresholds, as described herein. In certain embodiments, the PHY layer 212 may send an indication of beam failure to a MAC entity at the MAC sublayer 214. The MAC sublayer 214 offers logical channels (LCHs) to the RLC sublayer 216. The RLC sublayer 216 offers RLC channels to the PDCP sublayer 218.

The PDCP sublayer 218 offers radio bearers to the SDAP sublayer 220 and/or RRC layer 222. The SDAP sublayer 220 offers QoS flows to the core network (e.g., 5GC). The RRC layer 222 provides for the addition, modification, and release of carrier aggregation (CA) and/or dual connectivity. The RRC layer 222 also manages the establishment, configuration, maintenance, and release of signaling radio bearers (SRBs) and data radio bearers (DRBs).

The NAS layer 224 is between the UE 206 and an AMF in the 5GC 210. NAS messages are passed transparently through the RAN. The NAS layer 224 is used to manage the establishment of communication sessions and for maintaining continuous communications with the UE 206 as it moves between different cells of the RAN. In contrast, the AS layers 226 and 228 are between the UE 206 and the RAN (i.e., RAN node 208) and carry information over the wireless portion of the network. While not depicted in FIG. 2, the IP layer exists above the NAS layer 224, a transport layer exists above the IP layer, and an application layer exists above the transport layer.

The MAC sublayer 214 is the lowest sublayer in the L2 architecture of the NR protocol stack. Its connection to the PHY layer 212 below is through transport channels, and the connection to the RLC sublayer 216 above is through LCHs. The MAC sublayer 214 therefore performs multiplexing and demultiplexing between LCHs and transport channels: the MAC sublayer 214 in the transmitting side constructs MAC PDUs (also known as transport blocks (TBs)) from MAC service data units (SDUs) received through LCHs, and the MAC sublayer 214 in the receiving side recovers MAC SDUs from MAC PDUs received through transport channels.

The MAC sublayer 214 provides a data transfer service for the RLC sublayer 216 through LCHs, which are either control LCHs which carry control data (e.g., RRC signaling) or traffic LCHs which carry user plane data. On the other hand, the data from the MAC sublayer 214 is exchanged with the PHY layer 212 through transport channels, which are classified as uplink (UL) or downlink (DL). Data is multiplexed into transport channels depending on how it is transmitted over the air.

The PHY layer 212 is responsible for the actual transmission of data and control information via the air interface, i.e., the PHY layer 212 carries all information from the MAC transport channels over the air interface on the transmission side. Some of the important functions performed by the PHY layer 212 include coding and modulation, link adaptation (e.g., adaptive modulation and coding (AMC)), power control, cell search and random access (for initial synchronization and handover purposes) and other measurements (inside the 3GPP system (i.e., NR and/or LTE system) and between systems) for the RRC layer 222. The PHY layer 212 performs transmissions based on transmission parameters, such as the modulation scheme, the coding rate (i.e., the modulation and coding scheme (MCS)), the number of physical resource blocks (PRBs), etc.

In some embodiments, the protocol stack 200 may be an NR protocol stack used in a 5G NR system. Note that an LTE protocol stack comprises similar structure to the protocol stack 200, with the differences that the LTE protocol stack lacks the SDAP sublayer 220 in the AS layer 226, that an EPC replaces the 5GC 210, and that the NAS layer 224 is between the UE 206 and an MME in the EPC. Also note that the present disclosure distinguishes between a protocol layer (such as the aforementioned PHY layer 212, MAC sublayer 214, RLC sublayer 216, PDCP sublayer 218, SDAP sublayer 220, RRC layer 222 and NAS layer 224) and a transmission layer in multiple-input multiple-output (MIMO) communication (also referred to as a “MIMO layer” or a “data stream”).

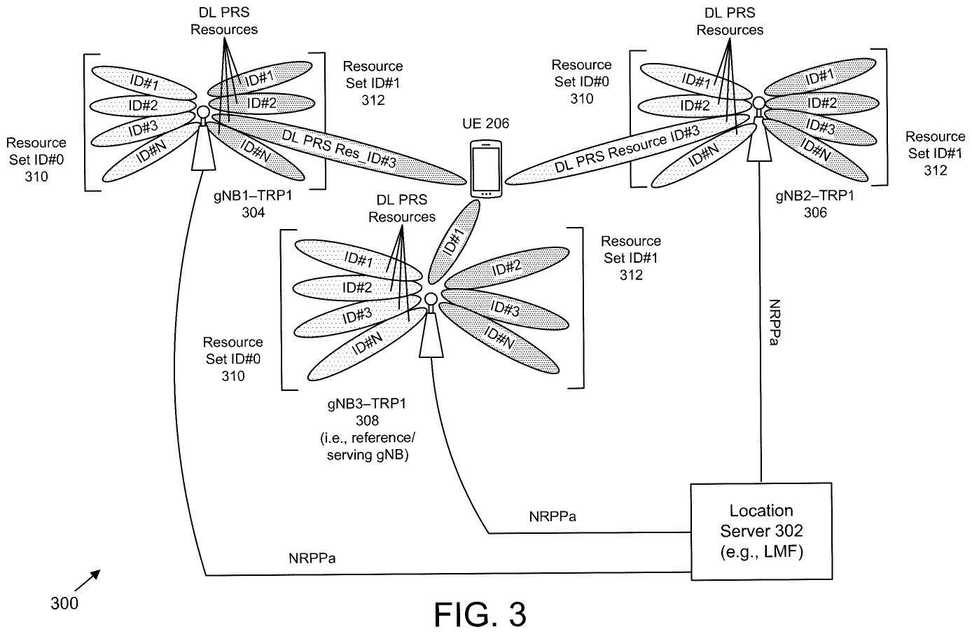

FIG. 3 illustrates a network architecture 300 for DL-based positioning measurements and reference signals (RS), in accordance with aspects of the present disclosure. Here, the DL PRS can be transmitted by different base stations (e.g., serving gNB and neighboring gNB(s)) using narrow beams over Frequency Range #1 (FR1) (i.e., frequencies from 410 MHz to 7125 MHz) and Frequency Range #2 (FR2) (i.e., frequencies from 24.25 GHz to 52.6 GHz), which is relatively different when compared to LTE where the PRS was transmitted across the whole cell. As illustrated in FIG. 3, a UE 206 may receive DL PRS from a neighboring first gNB/TRP (denoted “gNB1-TRP1”) 304, from a neighboring second gNB (denoted “gNB2-TRP1”) 306, and also from a third gNB/TRP (denoted “gNB3-TRP1”) 308 which is a reference or serving gNB.

Here, the DL PRS can be locally associated with a DL PRS Resource Identifier (ID) and Resource Set ID for a base station (i.e., TRP). In the depicted embodiments, each gNB/TRP 304, 306, 308 is configured with a first Resource Set ID (depicted as “Resource Set ID #0”) 310 and a second Resource Set ID (depicted as “Resource Set ID #1”) 312. As depicted, the UE 206 receives DL PRS on transmission beams; here, receiving DL PRS from the gNB1-TRP1 304 on DL PRS Resource ID #3 from the second Resource Set ID (“Resource Set ID #1”) 312, receiving DL PRS from the gNB2-TRP1 306 on DL PRS Resource ID #3 from the first Resource Set ID (“Resource Set ID #0”) 310, and receiving DL PRS from the gNB3-TRP1 308 on DL PRS Resource ID #1 from the second Resource Set ID (“Resource Set ID #1”) 312.

Similarly, UE positioning measurements such as RSTD and PRS RSRP measurements are made between different beams (e.g., between a different pair of DL PRS resources or DL PRS resource sets)—as opposed to different cells as was the case in LTE. A location server 302 (e.g., an LMF) uses the UE positioning measurements to determine the UE's location (e.g., absolute location). In addition, there are additional UL positioning methods for the network to exploit in order to compute the target UE's location. Table 2 and Table 3 show the RS-to-measurements mapping required for each of the supported RAT-dependent positioning techniques at the UE and gNB, respectively.

TABLE 2
UE Measurements to enable RAT-dependent
positioning techniques

| | | To facilitate |
|---|---|---|
| | | support of the |
| | | following |
| DL/UL Reference | | positioning |
| Signals | UE Measurements | techniques |
| Rel-16 DL PRS | DL RSTD | DL-TDOA |
| Rel-16 DL PRS | DL PRS RSRP | DL-TDOA, |
| | | DL-AoD, |
| | | Multi-RTT |
| Rel-16 DL PRS/Rel-16 | UE Rx − Tx time difference | Multi-RTT |
| Sounding Reference | | |
| Signal (SRS) for | | |
| positioning | | |
| Rel-15 Synchronization | SS-RSRP (RSRP for | E-CID |
| Signal Block (SSB)/ | RRM), SS-RSRQ (for | |
| Channel State | RRM), CSI-RSRP (for | |
| Information (CSI) | RRM), CSI-RSRQ (for | |
| RS for Radio Resource | RRM), SS-RSRPB (for | |
| Management (RRM) | RRM) | |

TABLE 3
gNB Measurements to enable RAT-
dependent positioning techniques

| | | To facilitate |
|---|---|---|
| | | support of the |
| | | following |
| DL/UL Reference | | positioning |
| Signals | gNB Measurements | techniques |
| Rel-16 SRS for | UL Relative Time of Arrival | UL-TDOA |
| positioning | (UL-RTOA) | |
| Rel-16 SRS for | UL SRS-RSRP | UL-TDOA, UL-AoA, |
| positioning | | Multi-RTT |
| Rel-16 SRS for | gNB Rx − Tx time difference | Multi-RTT |
| positioning, | | |
| Rel-16 DL PRS | | |
| Rel-16 SRS for | Angle-of-Arrival (AoA) and | UL-AoA, Multi-RTT |
| positioning, | Zenith-of-Arrival (ZoA) | |

Regarding RAT-dependent Positioning Measurements, the different DL measurements including DL PRS RSRP, DL RSTD and UE Rx-Tx Time Difference required for the supported RAT-dependent positioning techniques are shown in Table 4. The following measurement configurations may be specified: A) 4 Pair of DL RSTD measurements can be performed per pair of cells (each measurement is performed between a different pair of DL PRS Resources/Resource Sets with a single reference timing); B) 8 DL PRS RSRP measurements can be performed on different DL PRS resources from the same cell.

TABLE 4
DL PRS RSRP

| | |
|---|---|
| Definition | DL PRS RSRP is defined as the linear average over |
| | the power contributions (in [W]) of the resource |
| | elements that carry DL PRS reference signals configured |
| | for RSRP measurements within the considered measurement |
| | frequency bandwidth. |
| | For FR1, the reference point for the DL PRS-RSRP shall |
| | be the antenna connector of the UE. For FR2, DL PRS-RSRP |
| | is to be measured based on the combined signal from antenna |
| | elements corresponding to a given receiver branch. For FR1 |
| | and FR2, if receiver diversity is in use by the UE, the |
| | reported DL PRS-RSRP value shall not be lower than the |
| | corresponding DL PRS-RSRP of any of the individual |
| | receiver branches. |
| Applicable | RRC_CONNECTED intra-frequency, |
| for | RRC_CONNECTED inter-frequency |

TABLE 5
DL RSTD

| | |
|---|---|
| Definition | DL RSTD is the DL relative timing difference between the |
| | positioning node j and the reference positioning node i, |
| | defined as T_{SubframeRxj} − T_{SubframeRxi}, |
| | Where: |
| | T_{SubframeRxj} is the time when the UE receives the start |
| | of one subframe from positioning node j. |
| | T_{SubframeRxi} is the time when the UE receives the |
| | corresponding start of one subframe from positioning node |
| | i that is closest in time to the subframe received from |
| | positioning node j. |
| | Multiple DL PRS resources can be used to determine the |
| | start of one subframe from a positioning node. |
| | For FR1, the reference point for the DL RSTD shall be the |
| | antenna connector of the UE. For FR2, the reference point |
| | for the DL RSTD shall be the antenna of the UE. |
| Applicable | RRC_CONNECTED intra-frequency |
| for | RRC_CONNECTED inter-frequency |

TABLE 6
UE Rx − Tx time difference

| | |
|---|---|
| Definition | The UE Rx − Tx time difference is defined as T_{UE-RX} − |
| | T_{UE-TX} |
| | Where: |
| | T_{UE-RX} is the UE received timing of DL subframe #i |
| | from a positioning node, defined by the first detected path |
| | in time. |
| | T_{UE-TX} is the UE transmit timing of UL subframe #j |
| | that is closest in time to the subframe #i received from the |
| | positioning node. |
| | Multiple DL PRS resources can be used to determine the start |
| | of one subframe of the first arrival path of the positioning |
| | node. |
| | For FR1, the reference point for T_{UE-RX} measurement shall |
| | be the receive (Rx) antenna connector of the UE and the |
| | reference point for T_{UE-TX} measurement |
| | shall be the transmit (Tx) antenna connector of the |
| | UE. For FR2, the reference point for T_{UE-RX} |
| | measurement shall be the Rx antenna of the UE and the |
| | reference point for T_{UE-TX} measurement |
| | shall be the Tx antenna of the UE. |
| Applicable | RRC_CONNECTED intra-frequency |
| for | RRC_CONNECTED inter-frequency |

TABLE 7
DL PRS Reference Signal Received Path Power (RSRPP)

| | |
|---|---|
| Definition | DL PRS reference signal received path power (DL PRS- |
| | RSRPP) ,is defined as the power of the linear average |
| | of the channel response at the i-th path delay of the |
| | resource elements that carry DL PRS signal configured |
| | for the measurement, where DL PRS-RSRPP for the |
| | 1st path delay is the power contribution corresponding |
| | to the first detected path in time. |
| | For frequency range 1, the reference point for the DL PRS- |
| | RSRPP shall be the antenna connector of the UE. For |
| | frequency range 2, DL PRS-RSRPP shall be measured |
| | based on the combined signal from antenna elements |
| | corresponding to a given receiver branch. |
| Applicable | RRC_CONNECTED, |
| for | RRC_INACTIVE |

Additionally, the UL Angle of Arrival (UL AoA) is defined as the estimated azimuth angle (A-AoA) and vertical (zenith) angle (Z-AoA) of a UE with respect to a reference direction, wherein the reference direction is defined. The UL-AoA is determined at the gNB antenna for an UL channel corresponding to this UE.

In the global coordinate system, wherein estimated azimuth angle is measured relative to geographical North and is positive in a counter-clockwise direction and estimated vertical angle is measured relative to zenith and positive to horizontal direction.

In the local coordinate system, wherein estimated azimuth angle is measured relative to x-axis of the local coordinate system and positive in a counter-clockwise direction and estimated vertical angle is measured relative to z-axis of the local coordinate system and positive to x-y plane direction. The bearing, downtilt and slant angles of the local coordinate system are defined (e.g., according to 3GPP TS 38.901).

The UL Relative Time of Arrival (T_{UL-RTOA}) is the beginning of subframe i containing at least one sounding reference signal (SRS) received in a RP j, relative to the relative time of arrival (RTOA) reference time. The UL-RTOA reference time is defined as T₀+t_{SRS}, where T_0 T₀ is the nominal beginning time of system frame number (SFN) 0 provided by SFN initialization time (e.g., defined in 3GPP TS 38.455), and where t_{SRS}=(10n_{f}+n_{sf})×10⁻³, where n_{f} and n_{sf} are the system frame number and the subframe number of the SRS, respectively. Multiple SRS resources can be used to determine the beginning of one subframe containing SRS received at a RP.

The reference point for T_{UL-RTOA} is the Rx antenna connector for a type 1-C base station (e.g., as described in 3GPP TS 38.104); the Rx antenna (i.e., the center location of the radiating region of the Rx antenna) for a type 1-0 or 2-0 base station (e.g., as described in 3GPP TS 38.104), or the Rx transceiver array boundary connector for a type 1-H base station (e.g., as described in 3GPP TS 38.104).

The gNB Rx-Tx time difference is defined as T_{gNB-RX}−T_{gNB-TX}, where T_{gNB-RX} is the TRP received timing of UL subframe #i containing SRS associated with UE, defined by the first detected path in time, and where T_{gNB-TX} is the TRP transmit timing of DL subframe #j that is closest in time to the subframe #i received from the UE. Multiple SRS resources can be used to determine the start of one subframe containing SRS.

The reference point for the T_{gNB-RX} is the Rx antenna connector for a type 1-C base station (e.g., as described in 3GPP TS 38.104); the Rx antenna (i.e., the center location of the radiating region of the Rx antenna) for a type 1-0 or 2-0 base station (e.g., as described in 3GPP TS 38.104), or the Rx transceiver array boundary connector for a type 1-H base station (e.g., as described in 3GPP TS 38.104).

Similarly, the reference point for the T_{gNB-TX} is the Tx antenna connector for a type 1-C base station (e.g., as described in 3GPP TS 38.104); the Tx antenna (i.e., the center location of the radiating region of the Tx antenna) for a type 1-0 or 2-0 base station (e.g., as described in 3GPP TS 38.104), or the Tx Transceiver Array Boundary connector for a type 1-H base station (e.g., as described in 3GPP TS 38.104).

The UL SRS-RSRPP is defined as the power of the linear average of the channel response at the i-th path delay of the resource elements that carry the received UL SRS signal configured for the measurement, where UL SRS-RSRPP for 1st path delay is the power contribution corresponding to the first detected path in time.

The reference point for UL SRS-RSRPP is the Rx antenna connector for a type 1-C base station (e.g., as described in 3GPP TS 38.104); based on the combined signal from antenna elements corresponding to a given receiver branch for a type 1-0 or 2-0 base station (e.g., as described in 3GPP TS 38.104), or the Rx Transceiver Array Boundary connector for a type 1-H base station (e.g., as described in 3GPP TS 38.104).

For FR1 and FR2, if receiver diversity is in use by the gNB for UL SRS-RSRPP measurements, then: 1) The reported UL SRS-RSRPP value for the first and additional paths shall be provided for the same receiver branch(es) as applied for UL SRS-RSRP measurements, or 2) The reported UL SRS-RSRPP value for the first path shall not be lower than the corresponding UL SRS-RSRPP for the first path of any of the individual receiver branches and the reported UL SRS-RSRPP for the additional paths shall be provided for the same receiver branch(es) as applied UL SRS-RSRPP for the first path.

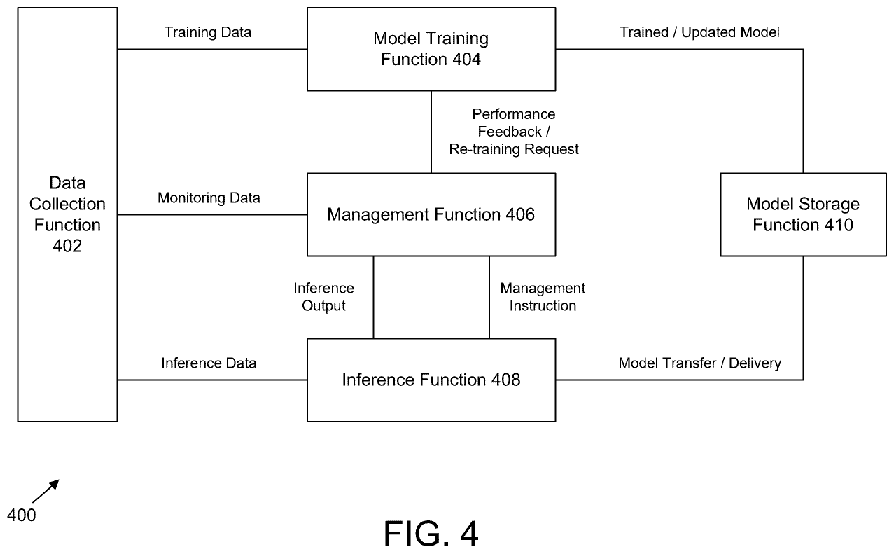

FIG. 4 illustrates an example of a functional framework 400 (i.e., a functional block diagram) for AI/ML for an air interface, in accordance with aspects of the present disclosure. The general framework consists of multiple processes that enable AI/ML functionality over the air interface.

The data collection function 402 is a function that provides input data to the model training function 404, the management function 406, and the inference function 408. For example, the training data refers to data needed as input for the AI/ML model training function 404. In another example, the monitoring data refers to data needed as input for the management of AI/ML models or AI/ML functionalities. As yet another example, the inference data refers to data needed as input for the AI/ML inference function 408.

The model training function 404 is a function that performs AI/ML model training, validation, and testing which may generate model performance metrics which can be used as part of the model testing procedure. The model training function 404 is also responsible for data preparation (e.g., data pre-processing and cleaning, formatting, and transformation) based on training data delivered by a data collection function, if required.

For example, in the case of having a model storage function 410, the model training function 404 is used to deliver trained, validated, and tested AI/ML models to the model storage function 410, or to deliver an updated version of a model to the model storage function 410.

The management function 406 is a function that oversees the operation (e.g., selection/(de)activation/switching/fallback) and monitoring (e.g., performance) of AI/ML models or AI/ML functionalities. The management function 406 is also responsible for making decisions to ensure the proper inference operation based on data received from the data collection function 402 and the inference function 408.

The management instruction is an output of the management function 406. The management instruction refers to information needed as input to manage the inference function 408. Concerning information may include selection/(de)activation/switching of AI/ML models or AI/ML-based functionalities, fallback to non-AI/ML operation (i.e., not relying on inference process), etc.

The model transfer/delivery request is another output of the management function 406 used to request model(s) to the model storage function 410. The performance feedback/retraining request is another output of the management function 406 and refers to information needed as input for the model training function 404, e.g., for model (re)training or updating purposes.

The inference function 408 is a function that provides outputs from the process of applying AI/ML models or AI/ML functionalities, using the data that is provided by the data collection function 402 (i.e., inference data) as an input. The inference function 408 is also responsible for data preparation (e.g., data pre-processing and cleaning, formatting, and transformation) based on inference data delivered by a data collection function 402, if required.

The inference output is an output of the inference function 408 and refers to data used by the management function 406 to monitor the performance of AI/ML models or AI/ML functionalities. As noted above, during the inference stage, the inference function 408 applies AI/ML models or AI/ML functionalities (e.g., using the inference data) to produce the inference output.

The model storage function 410 is a function responsible for storing trained/updated models that can be used to perform the inference function 408. Note that the model storage function 410 may be a reference point when applicable for protocol terminations, model transfer/delivery, and related processes. It should be stressed that its purpose does not encompass restricting the actual storage locations of models. Therefore, the impact of all data/information/instruction flows may be evaluated on a case by case basis.

The model transfer/delivery is an output of the model storage function 410 and is used to deliver an AI/ML model to the Inference function 408.

In the case of positioning accuracy enhancements, the following are selected as representative sub-use cases: A) direct AI/ML positioning; and B) AI/ML assisted positioning.

For the case of direct AI/ML positioning, the AI/ML model outputs the UE location. One example of direct AI/ML positioning includes fingerprinting based on channel observation as the input of AI/ML model.

For the case of AI/ML assisted positioning, the AI/ML model outputs new measurement and/or enhancement of existing measurement. For example, the AI/ML model may output LOS/NLOS identification, timing and/or angle of measurement, or likelihood of measurement information.

The following use cases are relevant to the present disclosure: Case 1, characterized by UE-based positioning with UE-side model, direct AI/ML or AI/ML assisted positioning; Case 2a, characterized by UE-assisted/LMF-based positioning with UE-side model, AI/ML assisted positioning; Case 2b, characterized by UE-assisted/LMF-based positioning with LMF-side model, direct AI/ML positioning; Case 3a, characterized by a next generation radio access network (NG-RAN) node assisted positioning with gNB-side model, AI/ML assisted positioning; and Case 3b, characterized by NG-RAN node assisted positioning with LMF-side model, direct AI/ML positioning.

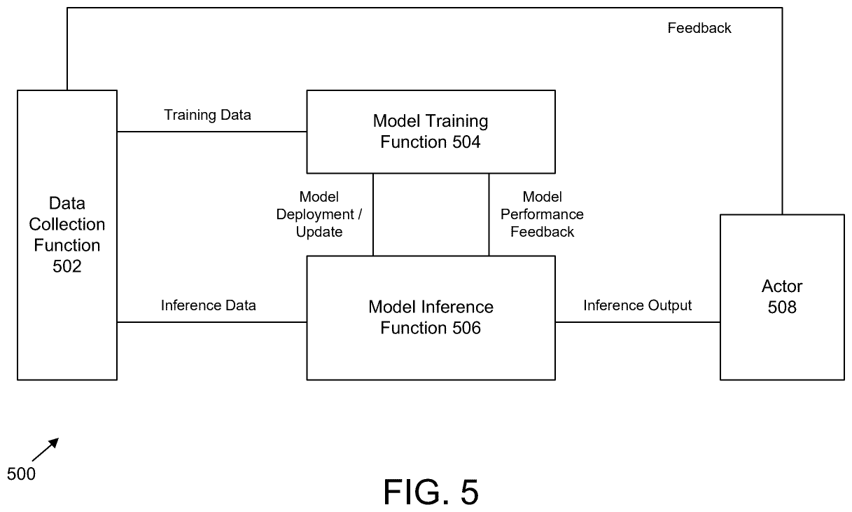

FIG. 5 illustrates another example of a functional framework 500 (i.e., a functional block diagram) for AI/ML for RAN intelligence, in accordance with aspects of the present disclosure. The general framework consists of multiple processes that enable AI/ML functionality over the air interface.

The data collection function 502 is a function that provides input data to the model training function 504 and the Model Inference function 506. AI/ML algorithm specific data preparation (e.g., data pre-processing and cleaning, formatting, and transformation) is not carried out in the data collection function 502. Examples of input data may include measurements from UEs or different network entities, feedback from the actor 508, and output from an AI/ML model.

The training data is an output of the data collection function 502 and refers to the data needed as input for the AI/ML model training function 504. The inference data is another output of the data collection function 502 and refers to the data needed as input for the AI/ML model inference function 506.

The model training function 504 is a function that performs the ML model training, validation, and testing which may generate model performance metrics as part of the model testing procedure. The model training function 504 is also responsible for data preparation (e.g., data pre-processing and cleaning, formatting, and transformation) based on training data delivered by a data collection function 502, if required.

The model deployment/update is an output of the model training function 504 which may be used to initially deploy a trained, validated, and tested AI/ML model to the model inference function 506, or to deliver an updated model to the model inference function 506.

The model inference function 506 is a function that provides AI/ML model inference output (e.g., predictions or decisions). In certain embodiments, the model inference function 506 provides model performance feedback to Model training function 504. The model inference function 506 is also responsible for data preparation (e.g., data pre-processing and cleaning, formatting, and transformation) based on inference data delivered by a data collection function 502, if required.

The inference output of the AI/ML model produced by a model inference function 506 may be provided to the actor 508. The model performance feedback is an optional output of the model inference function 506 which may be used for monitoring the performance of the AI/ML model, when available.

The actor 508 is a function that receives the output from the model inference function 506 and triggers or performs corresponding actions. The actor 508 may trigger actions directed to other entities or to itself. Accordingly, the actor 508 may output feedback, i.e., information that may be needed to derive training data, inference data or to monitor the performance of the AI/ML model and its impact to the network through updating of key performance indicators (KPIs) and performance counters.

In various embodiments, the UE 206 may support the functions of a positioning reference unit (PRU). In certain embodiments, a UE 206 that accesses the RAN node 208 and/or the 5GC 210 via an NR satellite shall not operate as a PRU.

The PRU supports service level association, association update and disassociation with a serving LMF. For example, the PRU may send service level association, association update or disassociation to LMF via LCS supplementary service message. In certain embodiments, the PRU may support association with multiple LMFs, e.g., for the case a PRU is in multiple LMF overlapped serving areas.

The PRU information included in a PRU association or PRU association update contains one or more than one of the following aspects: A) PRU Positioning Capabilities; B) Location information (if known); and C) the PRU ON/OFF state. Note that the PRU ON/OFF states may indicate temporarily availability of the PRU functionality of a UE at the serving LMF.

As used herein, a transmission point (TP) refers to a set of geographically co-located transmit antennas (e.g., antenna array (with one or more antenna elements)) for one cell, part of one cell or one PRS-only TP. TPs can include base station (eNodeB) antennas, remote radio heads, a remote antenna of a base station, an antenna of a PRS-only TP, etc. One cell can be formed by one or multiple TPs. For a homogeneous deployment, each TP may correspond to one cell.

As used herein, a reception point (RP) refers to a set of geographically co-located receive antennas (e.g., antenna array (with one or more antenna elements)) for one cell, part of one cell or one UL-SRS-only RP. RPs can include base station (ng-eNB or gNB) antennas, remote radio heads, a remote antenna of a base station, an antenna of a UL-SRS-only RP, etc. One cell can include one or multiple RPs. For a homogeneous deployment, each RP may correspond to one cell.

As used herein, a TRP refers to set of geographically co-located antennas (e.g., antenna array (with one or more antenna elements)) supporting TP and/or RP functionality.

As used herein, a “PRS-only TP” refers to a TP which only transmits PRS signals or DL-PRS for PRS-based TBS positioning and is not associated with a cell.

A positioning reference unit (PRU) at a known location can perform positioning measurements (e.g., RSTD, RSRP, UE Rx-Tx time difference measurements, etc.) and report these measurements to a location server. In addition, the PRU can transmit SRS to enable TRPs to measure and report UL positioning measurements (e.g., RTOA, UL-AoA, gNB Rx-Tx time difference, etc.) from PRU at a known location. The PRU measurements can be compared by a location server with the measurements expected at the known PRU location to determine correction terms for other nearby target devices. The DL- and/or UL location measurements for other target devices can then be corrected based on the previously determined correction terms. A PRU may also comprise of a TRP with a known location.

As used herein, the term “supported functionalities” refers to functionalities that UE can indicate by using UE capability information (via RRC and/or LTE positioning protocol (LPP) signaling). Similarly, the term “applicable functionalities” refers to functionalities that the UE is ready to apply at inference. Additionally, the term “activated functionalities” refers to functionalities already enabled for performing inference.

As used herein, the term “model monitoring” refers to a procedure that monitors the inference performance of the AI/ML model.

As used herein, the term “target device” refers to a radio node of interest (e.g., UE, gNB) whose position (e.g., absolute position or relative position) is to be obtained by the network or by the radio node itself, e.g., using one or more of the positioning methods described herein. As used herein, the terms artificial intelligence (AI) and machine learning (ML) are used interchangeably to refer to an intelligent software component or system. Accordingly, the notation “AI/ML” may be used to refer to the intelligent software component or system.

Described below are solutions to various scenarios in which AI/ML model functionality may be exchanged between the network entities and the UE. While presented as distinct solutions, one or more of the solutions described herein may be implemented in combination with each other. Note that in the present disclosure, any reference made to device (e.g., UE) position information (or location information) may refer to either an 2D/3D absolute position, 2D/3D relative position, distance, relative direction with respect to another node/entity, ranging in terms of distance, ranging in terms of direction or combination thereof.

The first solution describes a method to enable a UE-based (or target device-based) request-and-response framework for reporting performance monitoring outcome/results by a UE to a network entity, e.g., an LMF. Beneficially, the request-and-response framework enables the network entity to become aware if the UE-side AI/ML model performs well or requires any further network configuration adaptation, e.g., for the inference configuration. The request-and-response framework defines requests and responses to enable efficient transfer of the performance model monitoring outcomes/results associated with multiple AI/ML models and/or AI/ML functionalities.

The second solution describes a method to enable a RAN-based request-and-response framework for reporting performance monitoring outcome/results by a NG-RAN node (e.g., gNB) to a network entity, e.g., an LMF. Beneficially, the request-and-response framework enables the network entity to become aware if the NG-RAN-side (e.g., gNB-side) AI/ML model performs well or requires any further network configuration adaptation, e.g., for the inference configuration. The request-and-response framework defines requests and responses to enable efficient transfer of the performance model monitoring outcomes/results associated with multiple AI/ML models and/or AI/ML functionalities.

The third solution describes techniques and contents of performance monitoring outcome request messages to enable the transfer of the performance model monitoring outcomes/results. Furthermore, the network entity (e.g., location server, LMF, NWDAF) may include desired performance requirements, scheduled performance monitoring results/outcomes at a future time instance or time domain model/functionality performance outcome/result reporting criteria.

The fourth solution describes techniques and contents of performance monitoring outcome response messages to enable the transfer of the performance model monitoring outcomes/results. This solution addresses content features associated with the performance outcome/result report. Beneficially, meta-information associated with the performance monitoring outcome/results enables meaningful interpretation of the received outcome/results.

The fifth solution describes a techniques and procedures for requesting assistance data from a network entity related to the computation of the AI/ML monitoring metrics. Beneficially, the UE or NG-RAN node (e.g., gNB) may receive configuration information to aid in calculating performance monitoring outcome/results.

According to aspects of the first solution, a new type of procedure is defined wherein a network entity (e.g., location server, LMF, NWDAF) may request a UE (e.g., target device) to provide an outcome or result of the monitoring procedure. The UE may use one or more methods to determine the monitoring metric, which is used to derive the monitoring outcome. Note, however, that the model monitoring outcome is dependent on the calculated model monitoring metric.

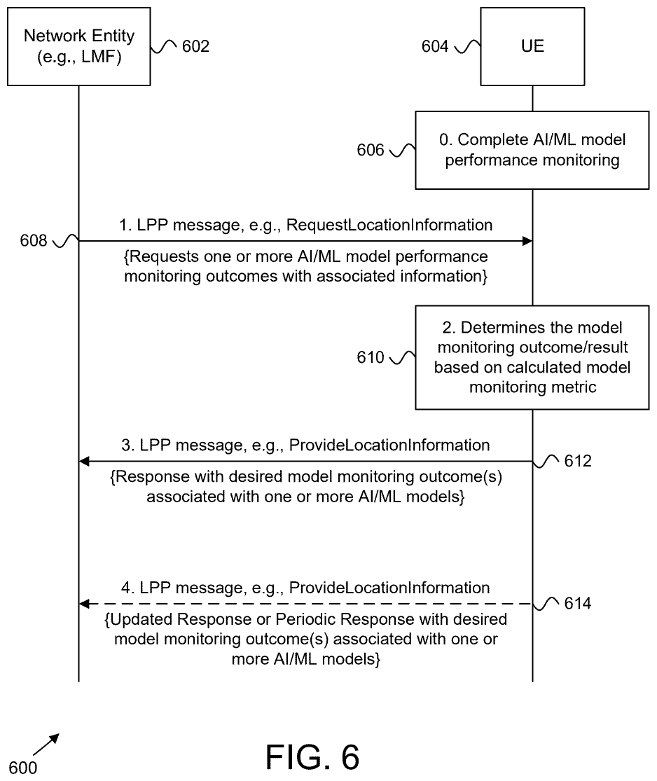

FIG. 6 illustrates an example of a procedure 600 for reporting performance monitoring results in accordance with aspects of the present disclosure. The procedure 600 may implement or be implemented by aspects of the wireless communications system 100, or may implement or be implemented by aspects of the protocol stack 200. For example, the procedure 600 may be performed between a network entity 602, which may be examples of a CN 106 (e.g., a location server, an LMF, or NWDAF) as described herein, and a UE 604, which may be examples of the UE 104 and/or UE 206.

In various implementations, the network entity 602 may request the performance monitoring outcome of one or more AI/ML models used for positioning including direct AI/ML poisoning or assisted AI/ML positioning performed at the UE-side. The steps of the procedure 600 are described as follows:

At step 0, the UE 604 (i.e., an example of a wireless communication device) may perform a performance model monitoring procedure based on its own implementation (see block 606), e.g., deriving model monitoring metrics to ascertain the performance of the various AI/ML models.

At step 1, the network entity 602 may transmit a request message to the UE 604 for model monitoring results/outcomes (see messaging 608). In some examples, the request message may include some associated meta-information regarding the monitoring results/outcomes, e.g., model monitoring requirements, reporting configuration and/or requirements, model monitoring statistics, model monitoring results at a future time instance/time interval, and so forth.

In some examples, the request message may additionally indicate the type of performance monitoring to be performed, e.g., model performance monitoring, model drift and degradation performance and/or model operational performance metrics.

Examples of model performance metrics may include classification accuracy, model precision, model recall, F1 score, the area under the curve-receiver operator characteristics (AUC-ROC), mean absolute error (MAE) and root mean square error (RMSE), R-Loss (Goodness of fit), Log-loss/Cross-Entropy loss. Other examples include classical statistical metrics, such as mean, variance, standard deviation, etc.

As used herein, the model precision is a measurement of how many predicted positives were actually correct. In some examples, the model precision is calculated as the number of true positives divided by the sum of true positives and false positives. Beneficially, optimizing the model precision assists in avoiding false positives.

As used herein, the model recall is a measurement of how many actual positives were correctly identified. In some examples, the model precision is calculated as the number of true positives divided by the sum of true positives and false negatives. The model recall metric may also be referred to as the model sensitivity or the true positive rate. Beneficially, optimizing the model recall assists in avoiding false negatives.

As used herein, the F1 score is a performance metric for classification models that balances the model precision and the model recall. The F1 score may be beneficial in situations where there is an imbalance between classes (i.e., one class is significantly more frequent than another). In some examples, the F1 score is calculated as twice the product of the model precision multiplied by the model recall, all divided by the sum of the model precision and the model recall. Beneficially, optimizing the F1 score assists in avoiding overemphasis of true negatives when training or tuning/adjusting an AI/ML model.

As used herein, the AUC-ROC is a performance metric that measures the trade-off between true positives and false positives of positioning performance. As used herein, the Log-loss/Cross-Entropy loss measures model confidence in regression tasks, e.g., for determining a UE's position.

Examples of model drift and degradation metrics include prediction drift (i.e., changes in the statistical predictions over time), concept drift (i.e., evaluate if the statistical properties of a target/selected variable (e.g., positioning accuracy) change over time.

Examples of model operational metrics include latency (i.e. time taken by the model to generate predictions), throughput (i.e. the number of predictions or derived UE locations per second), Uptime (i.e. the percentage of time the model is operational), and resource utilization (e.g. central processing unit (CPU), graphic processing unit (GPU), memory usage during inference, UE battery life, UE energy consumed during inference, etc.)

At step 2, the UE 604 determines a method to translate the model monitoring metrics to model monitoring outcomes/results such that it can be interpreted and/or understood by other network entities, NG-RAN nodes, and/or UEs (see block 610). In some examples, the model monitoring outcomes/results may include high-level information describing the model monitoring outcomes/results, in terms of hard decision/flag performance indicators/ratings, e.g., ‘Good’, ‘Satisfactory’, ‘Bad’, or grades such as A=Excellent, B=Good, C=Satisfactory/Pass, D=Bad, E=Very bad, or binary indicators, e.g., ‘0’ for poor performing model or ‘1’ for high performing models.

In some examples, the model monitoring outcomes/results may include soft decision/performance indicators such as probabilities, performance percentage values, goodness descriptions, and so forth. In one implementation, the probabilities may be expressed as one or more values between ‘0’ and ‘1’, e.g., {0, 0.1, . . . , 0.9, 1}, where ‘0’ indicates a very bad performing model, while ‘0.9’, ‘1’ indicate a great performing model. In one implementation, the performance percentage values as a value between ‘0’ and ‘99’ or between ‘0’ and ‘100’, e.g., ‘0%’ indicates a very poor performing or inaccurate model while ‘99%’ or ‘100%’ indicates a very well performing model.

At step 3, the UE 604 reports the one or more monitoring outcome/results for one or more AI/ML models (or AI/ML functionalities) to the network entity 602 in a response message (see messaging 612). In certain implementation, the monitoring outcome/results may also be based on the requested information in Step 1.

At optional step 4, the UE 604 may optionally report additional model monitoring outcome/results to the network entity 602 when a reporting criterion is met, such as when an update to the performance monitoring result is required, or when periodical monitoring results are required (see messaging 614).

In some implementations, in the event that the performance model monitoring result cannot be computed or is unavailable for whatever reason, the UE 604 may indicate the unavailability of the monitoring outcome/result via a separate indication/error cause.

According to one aspect of the first solution, multiple performance monitoring metrics may be used to evaluate the overall performance of a single AI/ML (positioning) model. One or more model monitoring metrics of may be used to derive a single monitoring outcome/result associated to a single AI/ML (positioning) model, which may then be transferred/reported to another network entity, NG-RAN node or target device (e.g. UE). This may also be extended to multiple AI/ML models, wherein multiple monitoring outcomes/results associated to each AI/ML model may also be reported.

According to another implementation of this first solution, multiple performance monitoring metrics may be used to evaluate the overall performance of a functionality of a set of one or more AI/ML models. For example, if the functionality is related to determining the horizontal positioning/location estimate via direct AI/ML positioning, then the monitoring outcome/result may be related to one or more AI/ML models, which may be used to derive the functionality of providing the horizontal positioning/location estimate. Other functionalities may include vertical location/position estimate, relative direction estimates with respect to another network node or the UE 604, distance (range) estimates with respect to another network node or the UE 604. Therefore, the reported performance monitoring outcome/result is not related solely to any one or more AI/ML models but rather the desired functionality, irrespective of whether one AI/ML model is used, or multiple AI/ML models are used to achieve the desired functionality.

In another implementation of this first solution, the UE 604 may transmit/report the performance monitoring result/outcome in an unsolicited manner to the network entity 602. The trigger for reporting may include the availability of the performance monitoring outcome/result if the positioning accuracy/monitoring metric fall below a configured threshold.

According to another aspect of the first solution, the UE-based model monitoring outcome request-and-reporting framework may be based on LPP messages, secure user plane (SUPL) messages, supplementary service (SS) messages, LCS User Plane Positioning (LCS-UPP) protocol, or a combination thereof. In other implementations, lower layer signalling such as RRC or DL/UL MAC control element (CE) may also be employed in the request-and-reporting framework.

In another aspect of the embodiment, the network entity 602 may request and receive the performance monitoring outcome/results of the UE 604 via another network function (NF) in the CN 106. For example, the network entity may be implemented by a NWDAF that requests and receives the performance monitoring outcome/results via a LMF or via an AMF. In other implementations, the network entity 602 may request and receive the performance monitoring outcome/results of the UE 604 directly, i.e. provided there is a direct interface between the UE 604 and network entity 602 (e.g. NWDAF). This is applicable to the scenario, when the NWDAF desires information about the model/functionality performance monitoring outcome/results.

In another implementation of this embodiment, the UE 604 may transmit/report the performance monitoring outcome/result to another UE 604, e.g., a server UE, or an anchor UE, or a PRU. The transfer may be performed using an Over-the-top (OTT) server or using the standardized sidelink positioning protocol (SLPP), e.g., using the SLPP RequestLocationlnformation message and SLPP ProvideLocationlnformation message to carry sidelink (SL) positioning information including the additional AI/ML information such as the performance monitoring results/outcome. Similarly, the UE 604 may transmit/report the performance monitoring outcome/result to a base station or NG-RAN node (e.g. gNB).

According to one implementation, before or near the first time that the UE 604 transmits the performance monitoring outcome/result for an AI/ML model/functionality, the UE 604 additionally provides information regarding the statistics of the AI/ML model/functionality monitoring scheme itself. For example, the UE 604 may provide metrics such as the accuracy, precision, recall, or F1 score or other classical statistical metrics (e.g., mean, variance, standard deviation, etc.) of the monitoring scheme that it has used to determine the model monitoring output. Beneficially, this statistical information may give the network entity 602 some understanding of the model monitoring scheme that has been used at the UE 604 without disclosing the model monitoring scheme and/or model monitoring metrics themselves, which may be proprietary.

According to aspects of the second solution, a new type of procedure is defined wherein a network entity (e.g., location server, LMF, NWDAF) may request a NG-RAN node (e.g., gNB, TRP) to provide an outcome or result of the monitoring procedure. The NG-RAN node may use one or more methods to determine the monitoring metric, which is used to derive the monitoring outcome. Note, however, that the model monitoring outcome is dependent on the calculated model monitoring metric.

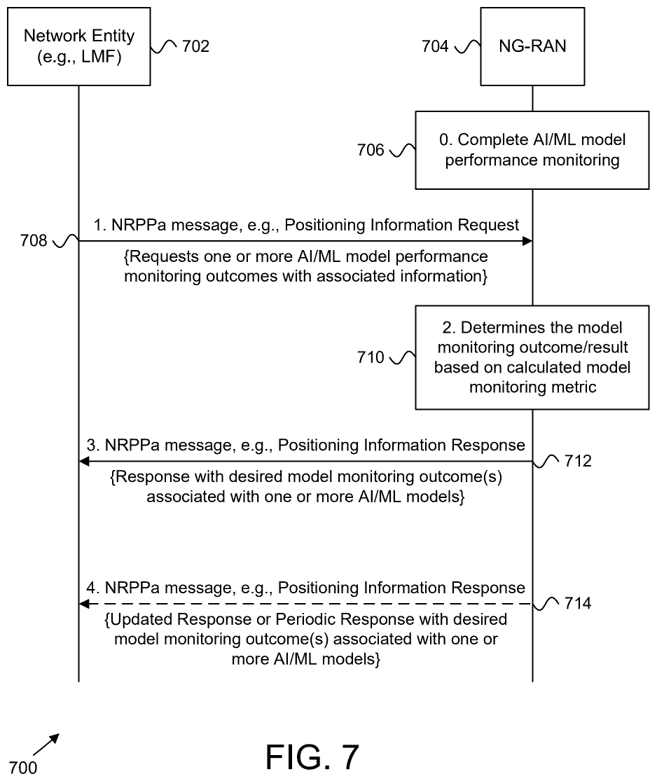

FIG. 7 illustrates an example of a procedure 700 for reporting performance monitoring results in accordance with aspects of the present disclosure. The procedure 700 may implement or be implemented by aspects of the wireless communications system 100, or may implement or be implemented by aspects of the protocol stack 200. For example, the procedure 700 may be performed between a network entity 702, which may be examples of a CN 106 (e.g., a location server, an LMF, or NWDAF) as described herein, and a NG-RAN node 704, which may be examples of the NE 102 and/or RAN node 208.

In various implementations, the network entity 702 may request the performance monitoring outcome of one or more AI/ML models used for positioning including direct AI/ML poisoning or assisted AI/ML positioning performed at the UE-side. The steps of the procedure 700 are described as follows:

At step 0, the NG-RAN node 704 (i.e., an example of a wireless communication device) may perform a performance model monitoring procedure based on its own implementation (see block 706), e.g., deriving model monitoring metrics to ascertain the performance of the various AI/ML models.

At step 1, the network entity 702 may transmit a request message to the NG-RAN node 704 for model monitoring results/outcomes (see messaging 708). In some examples, the request message may include some associated meta-information regarding the monitoring results/outcomes, e.g., model monitoring requirements, reporting configuration and/or requirements, model monitoring statistics, model monitoring results at a future time instance/time interval, and so forth.

In some examples, the request message may additionally indicate the type of performance monitoring to be performed, e.g., model performance monitoring, model drift and degradation performance and/or model operational performance metrics. Examples of model performance metrics are described above with respect to Step 1 of the procedure 600.

At step 2, the NG-RAN node 704 determines a method to translate the model monitoring metrics to model monitoring outcomes/results such that it can be interpreted and/or understood by other network entities, NG-RAN nodes, and/or UEs (see block 710). In some examples, the model monitoring outcomes/results may include high-level information describing the model monitoring outcomes/results, in terms of hard decision performance indicators/ratings. In some examples, the model monitoring outcomes/results may include soft performance indicators such as probabilities, performance percentage values, goodness descriptions, and so forth.

At step 3, the NG-RAN node 704 reports the one or more monitoring outcome/results for one or more AI/ML models (or AI/ML functionalities) to the network entity 702 in a response message (see messaging 712). In certain implementation, the monitoring outcome/results may also be based on the requested information in Step 1.

At optional step 4, the NG-RAN node 704 may optionally report additional model monitoring outcome/results to the network entity 702 when a reporting criterion is met, such as when an update to the performance monitoring result is required, or when periodical monitoring results are required (see messaging 714).

In some implementations, in the event that the performance model monitoring result cannot be computed or is unavailable for whatever reason, the NG-RAN node 704 may indicate the unavailability of the monitoring outcome/result via a separate indication/error cause.

According to one aspect of the second solution, multiple performance monitoring metrics may be used to evaluate the overall performance of a single AI/ML (positioning) model. One or more model monitoring metrics of may be used to derive a single monitoring outcome/result associated to a single AI/ML (positioning) model, which may then be transferred/reported to another network entity, NG-RAN node or target device (e.g. UE). This may also be extended to multiple AI/ML models, wherein multiple monitoring outcomes/results associated to each AI/ML model may also be reported.

According to another implementation of this second solution, multiple performance monitoring metrics may be used to evaluate the overall performance of a functionality of a set of one or more AI/ML models. For example, if the functionality is related to determining the horizontal positioning/location estimate via direct AI/ML positioning, then the monitoring outcome/result may be related to one or more AI/ML models, which may be used to derive the functionality of providing the horizontal positioning/location estimate. Other functionalities may include vertical location/position estimate, relative direction estimates with respect to another network node or the NG-RAN node 704, distance (range) estimates with respect to another network node or the NG-RAN node 704. Therefore, the reported performance monitoring outcome/result is not related solely to any one or more AI/ML models but rather the specific functionality, irrespective of whether one AI/ML model is used, or multiple AI/ML models are used to achieve the specific functionality.

In another implementation of this second solution, the NG-RAN node 704 may transmit/report the performance monitoring result/outcome in an unsolicited manner to the network entity 702. The trigger for reporting may include the availability of the performance monitoring outcome/result if the positioning accuracy/monitoring metric falls below a configured threshold.

According to another aspect of the second solution, the RAN-based model monitoring outcome request-and-reporting framework may be based on NR positioning protocol annex (NRPPa) signaling/messages. In other implementations, the request-and-reporting framework may be based on any other NF interfaces, e.g., N1 and N2 interface. The N1 interface is a transparent interface from UE to the AMF, which is employed to transfer UE information (related to connection, mobility and sessions) to the AMF, of which AI/ML positioning information shared with the AMF from UE, e.g., model monitoring outcome/results can then be forwarded it to the LMF. The N2 connects the NG-RAN node (e.g., gNB) to the AMF, of which AI/ML positioning information shared with the AMF from the NG-RAN node, e.g., model monitoring outcome/results can then be forwarded it to the LMF.

In another aspect of the embodiment, the network entity 702 may request and receive the performance monitoring outcome/results of the NG-RAN node 704 via another network function (NF) in the CN 106. For example, the network entity may be implemented by a NWDAF that requests and receives the performance monitoring outcome/results via a LMF or via an AMF. In other implementations, the network entity 702 may request and receive the performance monitoring outcome/results of the NG-RAN node 704 directly, i.e. provided there is a direct interface between the NG-RAN node 704 and network entity 702 (e.g. NWDAF).

According to one implementation, before or near the first time that the NG-RAN node 704 transmits the performance monitoring outcome/result for an AI/ML model/functionality, the NG-RAN node 704 additionally provides information regarding the statistics of the AI/ML model/functionality monitoring scheme itself. For example, the NG-RAN node 704 may provide metrics such as the accuracy, precision, recall, or F1 score or other classical statistical metrics (e.g., mean, variance, standard deviation, etc.) of the monitoring scheme that it has used to determine the model monitoring output. Beneficially, this statistical information may give the network entity 702 some understanding of the model monitoring scheme that has been used at the NG-RAN node 704 without disclosing the model monitoring scheme and/or model monitoring metrics themselves, which may be proprietary.

According to aspects of a third solution, the model monitoring outcome/result request message may include one or more sets of parameters, e.g., to define and initiate a request for one or more model monitoring outcomes. In some examples, the message contents described herein may be included in the request message sent in Step 1 of the procedure 600 (i.e., UE-based performance model reporting) and/or Step 1 of the procedure 700 (i.e., RAN-based performance model reporting).

Accordingly, the reporting contents may be defined for a UE or NG-RAN node, wherein a network entity (e.g., location server or LMF) may trigger and initiate a request for one or more model monitoring outcomes. In some examples, the network entity may further indicate additional meta-information that may be associated with the model monitoring outcome request, e.g., in terms of desired requirements. Table 5 Tables 8-10 depicts some exemplary message contents of the model monitoring outcome/result request message.

TABLE 8
Model-based Request Parameters

| Parameter | Exemplary Value(s) | Description |
|---|---|---|
| >Model index | | Requests a list of performance monitoring |
| list | | outcomes/results per AI/ML positioning |
| | | model at a target device (e.g. UE or NG-RAN |
| | | node) |
| >>Model ID | {AI/ML positioning Model | Request the performance monitoring |
| | ID 1, AI/ML positioning | outcomes/results according to a specific |
| | Model ID 2, and so on} | Model ID, e.g., AI/ML positioning model ID |
| >>Desired | {horizontal positioning | This information elements conveys any |
| Performance | accuracy, vertical | expected/desired performance monitoring |
| Requirements | positioning accuracy, | requirements/QoS, e.g., in term of desired |
| | direction accuracy, | performance accuracy. In one example |
| | distance (range) accuracy, | implementation, the network entity, e.g., |
| | cumulative distribution | LMF may request a certain performance |
| | function (CDF), | threshold or CDF/PDF accuracy for reporting |
| | probability distribution | the accuracy performance of the model. |
| | function (PDF), response | In another implementation, if the |
| | time} | performance monitoring is below a required |
| | | threshold, then the target device (e.g. UE or |
| | | NG-RAN node) is required to report the |
| | | performance monitoring outcome/result. |
| | | Conversely, if the if the performance |
| | | monitoring is above a required threshold, the |
| | | target device (e.g. UE or NG-RAN node) is |
| | | not required to report the performance |
| | | monitoring outcome/result. A performance |
| | | monitoring outcome/result response time may |
| | | be configured in which the performance |
| | | monitoring outcome/result is expected within |
| | | a certain specified time instance/time |
| | | interval. |
| >>performance | | This field shows the duration over which the |
| windows | | performance metric should be averaged to |
| configuration | | determine the performance of the model. For |
| | | example, how long the positioning accuracy |
| | | should be less than a threshold before the |
| | | target device (e.g. UE or NG-RAN node) |
| | | reports the model is not working. One or |
| | | more windows with a specified start time, |
| | | end time, window length, window periodicity |
| | | may be configured. |
| >>Performance | {TRUE, FALSE} | The LMF may request some meta- |
| Monitoring | | information associated with model |
| Statistics | | monitoring metric calculation in the form of |
| | | some statistical information regarding the |
| | | monitoring metric and/or a reliability of the |
| | | metric. In extended implementations, the type |
| | | of statistics may also be requested. |

TABLE 9
Functionality-Based Request Parameters

| Parameter | Exemplary Value(s) | Description |
|---|---|---|
| >Functionality | | Requests a list of performance monitoring |
| index list | | outcomes/results per functionality associated |
| | | to one or more AI/ML positioning models at |
| | | the target device (e.g. UE or NG-RAN node) |
| >>Functionality | {AI/ML positioning | Request the performance monitoring |
| ID (Associated ID) | Functionality ID 1, | outcomes/results according to a specific |
| | AI/ML positioning | functionality ID, e.g., AI/ML positioning |
| | Functionality ID 2, and | functionality ID or associated ID |
| | so on} | |
| >>Desired | {horizontal positioning | This information elements conveys any |
| Functionality | accuracy, vertical | expected/desired performance monitoring |
| Performance | positioning accuracy, | requirements/QoS, e.g., in term of desired |
| Requirements | direction accuracy, | performance accuracy. In one example |
| | distance (range) | implementation, the network entity, e.g., LMF |
| | accuracy, CDF, PDF, | may request a certain performance threshold or |
| | response time} | CDF/PDF accuracy for reporting the accuracy |
| | | performance of the functionality. |
| | | In another implementation, if the performance |
| | | monitoring is below a required threshold, then |
| | | the target device (e.g. UE or NG-RAN node) is |
| | | required to report the performance monitoring |
| | | outcome/result. Conversely, if the if the |
| | | performance monitoring is above a required |
| | | threshold, the target device (e.g. UE or NG- |
| | | RAN node) is not required to report the |
| | | performance monitoring outcome/result. A |
| | | performance monitoring outcome/result |
| | | response time may be configured in which the |
| | | performance monitoring outcome/result is |
| | | expected within a certain specified time |
| | | instance/time interval. |
| >>performance | | This field shows the duration over which the |
| windows | | performance metric should be averaged to |
| configuration | | determine the performance of the model. For |
| | | example, how long the positioning accuracy |
| | | should be less than a threshold before the target |
| | | device (e.g. UE or NG-RAN node) report the |
| | | functionality is not working. One or more |
| | | windows with a specified start time, end time, |
| | | window length, window periodicity may be |
| | | configured. |
| >>Performance | {TRUE, FALSE} | The LMF may request some meta-information |
| Functionality | | associated with functionality monitoring metric |
| Monitoring | | calculation in the form of some statistical |
| Statistics | | information regarding the monitoring metric |
| | | and/or a reliability of the metric. In extended |
| | | implementations, the type of statistics may also |
| | | be requested |

TABLE 10
Additional Request Parameters

| Parameter | Exemplary Value(s) | Description |
|---|---|---|
| >Scheduled | | This field indicates that the target device |
| Performance | | (e.g. UE or NG-RAN node) is requested |
| Monitoring | | to provide the monitoring outcome/result |
| outcome/result in | | valid at the scheduled Time T in the |
| advance | | future and comprises the following |
| | | subfields. |
| | | UTC time: Indicates time T in UTC in the |
| | | form of YYYY-MM-DD-hh-mm-ss |
| | | GNSS Time: Indicates time T in GNSS |
| | | system time of the GNSS indicated by |
| | | gnss-TimeID |
| | | Network Time: Comprising E-UTRA or |
| | | NR time |
| >Performance | | This field indicates the time domain |
| Monitoring | | method in which the target device (e.g. |
| outcome/result | | UE or NG-RAN node) should provide the |
| reporting criteria | | report |
| >>One Shot | | If this field is included, the target device |
| Reporting | | (e.g. UE or NG-RAN node) may provide |
| | | a one shot/single instance transmission of |
| | | the performance monitoring |
| | | outcome/result. |
| >>Periodical | {Number of Reports, | If this field is included, the target device |
| Reporting | Reporting interval} | (e.g. UE or NG-RAN node) may |
| | | periodically provide the network entity, |
| | | e.g., LMF with the performance |
| | | monitoring result. |
| >>Triggered | {Example Event: if | If this field is included, this field indicates |
| Reporting | performance outcome/result | that the target device (e.g. UE or NG- |
| | drops below a configured | RAN node) may perform triggered |
| | threshold, if the UE mobility | reporting of the performance monitoring |
| | changes from a stationary | result/outcome based on certain defined |
| | state to a mobile state, and | events and triggering of these events. |
| | so forth} | |
| >Prioritization List | {Descending order of | This field may request performance |
| | priority, Ascending order of | monitoring results/outcomes of |
| | priority, explicit priority | models/functionalities according to |
| | indicators} | configured priority of interest |

According to aspects of a fourth solution, the model monitoring outcome/result response message may include one or more sets of parameters, e.g., based on a mapping of performance metrics to outcomes/results configured by the associated request message. In some examples, the response message contents described herein may be included in the response message sent in Step 3 of the procedure 600 (i.e.. UE-based performance model reporting) and/or Step 3 of the procedure 700 (i.e., RAN-based performance model reporting).

Accordingly, the reporting contents may be defined for a UE or NG-RAN node, wherein a network entity (e.g., location server or LMF) may receive a response for one or more model monitoring outcomes. In some examples, the response message may further indicate preferences associated with the ground truth information within the request message. Tables 11-13 depicts some exemplary message contents of the model monitoring outcome/result request message.

TABLE 11
Model-based Response Parameters

| Parameter | Exemplary Value(s) | Description |
|---|---|---|
| >Model ID | | This field provides the |
| | | performance monitoring |
| | | outcome/result of an |
| | | AI/ML Model ID, e.g., |
| | | AI/ML positioning model. |
| | | If a prioritization field is |
| | | included, then the performance |
| | | monitoring outcome/results |
| | | are prioritized according to |
| | | the requested models. |
| >>Performance | This can be high-level | This field provides any related |
| Monitoring | information describing | information describing the |
| Result/Outcome | the model monitoring | performance of an AI/ML |
| | outcomes/results in terms | model, e.g., AI/ML |
| | of either the described model- | positioning model. |
| | specific parameters or positioning | |
| | model performance, e.g., horizontal | |
| | accuracy, vertical accuracy, overall | |
| | location estimate accuracy. | |
| | Examples include positioning | |
| | accuracy or hard or soft decision | |
| | outcomes/results. | |

TABLE 12
Functionality-Based Response Parameters

| Parameter | Exemplary Value(s) | Description |
|---|---|---|
| >Functionality ID | | This field provides the |
| | | performance monitoring |
| | | outcome/result of an AI/ML |
| | | functionality ID, e.g., AI/ML |
| | | positioning functionality, e.g., |
| | | direct AI/ML positioning and/or |
| | | assisted AI/ML positioning, |
| | | horizontal absolute location, |
| | | vertical absolute location, and so |
| | | forth. |
| | | If a prioritization field is |
| | | included, then the performance |
| | | monitoring outcome/results are |
| | | prioritized according to the |
| | | requested functionalities. |
| >>Performance | This can be high-level information | This field provides any related |
| Monitoring | describing the model monitoring | information describing the |
| Result/Outcome | outcomes/results in terms of either | performance of an AI/ML |
| | the described model-specific | functionality, e.g., AI/ML |
| | parameters or positioning | positioning functionality. |
| | performance, e.g., horizontal | |
| | accuracy, vertical accuracy. | |
| | Examples include positioning | |
| | accuracy or hard or soft decision | |
| | outcomes/results. | |

TABLE 13
Additional Response Parameters

| Parameter | Exemplary Value(s) | Description |
|---|---|---|
| >Performance | | This field provides any related |
| Monitoring | | information on the |
| Result/Outcome | | quality/confidence/uncertainty of the |
| Quality Indicator | | reported performance monitoring result. |
| >Performance | | This field provides timestamp |
| Monitoring | | information conveying the time |
| Result/Outcome | | instance at which one or more |
| Timestamp | | performance results/outcome are |
| | | reported. The timestamp can be |
| | | described in a variety of time bases, |
| | | e.g., as described for the ‘Scheduled |
| | | Performance Monitoring |
| | | outcome/result in advance’ information |
| | | field. |
| >Monitoring Metric | | This field is used by the target device |
| Calculation Source | | (e.g. UE or NG-RAN node) to indicate |
| | | how the performance monitoring |
| | | result/outcome was computed. |
| >Monitoring scheme | | This field represents the statistics about |
| statistics | | the model/functionality scheme itself. It |
| | | conveys information such as accuracy, |
| | | precision, recall, false alarm, F1 score |
| | | of scheme used for monitoring of the |
| | | model/functionality. |
| | | This information might be transmitted |
| | | only once for each of the model/ |
| | | functionality monitoring schemes, and |
| | | may be updated in the model/ |
| | | functionality monitoring scheme |
| | | changes during operation of the node. |
| >Performance | {Performance Monitoring | This field indicates whether the |
| Monitoring | Result/Outcome | requested performance monitoring |
| Result/Outcome | Unavailable, Unable to | result is unavailable or whether an error |
| Failure/Unavailability | compute Performance | cause can be transmitted associated to |
| | Monitoring | the computation of the monitoring |
| | Result/Outcome, | metric. |
| | Model/Functionality not | |
| | available to determine | |
| | Performance Monitoring | |
| | Result/Outcome} | |
| >Performance | | This field provides any related |
| Monitoring | | information on the |
| Result/Outcome | | quality/confidence/uncertainty of the |
| Quality Indicator | | reported performance monitoring result. |

Regarding the performance monitoring result/outcome values described in Tables 11 and 12, examples of the model monitoring outcomes/results include hard decision performance indicators and soft decision/performance indicators.

The hard decision performance indicators may include ratings (e.g., ‘Good’, ‘Satisfactory’, ‘Bad’) or binary indicators (e.g., ‘0’ for poor performing model or ‘1’ for high performing models). The soft decision/performance indicators may include probabilities (e.g., {0, 0.1, . . . , 0.9, 1}, where ‘0’ indicates a very bad performing model, while ‘0.9’, ‘1’ indicates a great performing model), performance percentage values (e.g., ‘000’ indicates a very poor performing or inaccurate model while ‘99%’ or ‘100%’ indicates a very well performing model), goodness descriptions, and so forth.

Additional examples of the model monitoring outcomes/results include positioning accuracy (e.g., expressed in terms of cm, meters, etc.) and direction accuracy (e.g., expressed in terms of radians or degrees).

In various implementations, the response message may be realized as part of an existing positioning method, e.g., DL-TDOA or DL-AoD or as part of a new separate AI/ML positioning method, e.g., direct AI/ML positioning or assisted AI/ML positioning.

According to aspects of a fifth solution, the UE or NG-RAN node may request a network entity (e.g., location server, LMF, NWDAF) for assistance data or configuration information/data related to the computation of the model monitoring metric. In other words, this assistance data or configuration information may help/aid the UE or NG-RAN in computing one or more monitoring metrics related to the determination and evaluation of the one or more AI/ML model performance parameters/metrics, which in turn assists in the derivation of the functionality/model monitoring outcome/result.

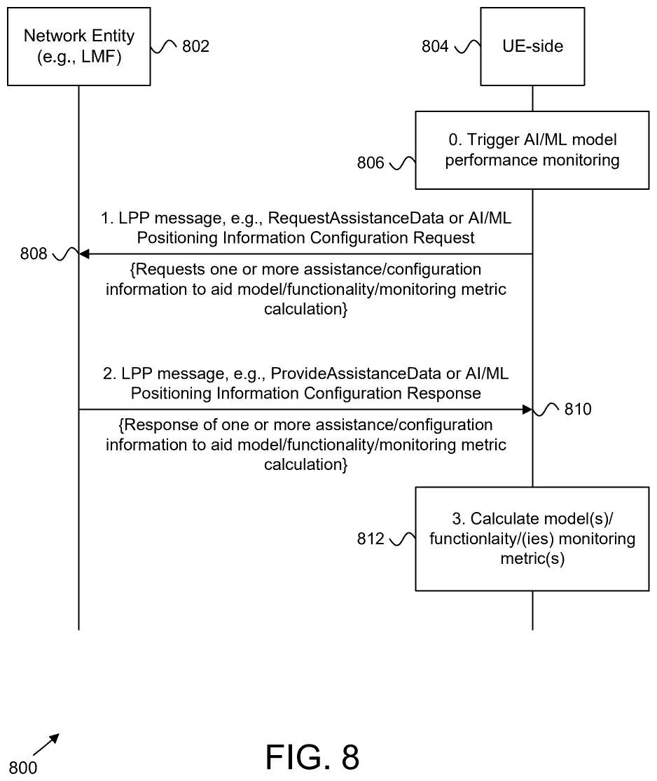

FIG. 8 illustrates an example of a procedure 800 for requesting assistance information or configuration information, in accordance with aspects of the present disclosure. The procedure 800 may implement or be implemented by aspects of the wireless communications system 100, or may implement or be implemented by aspects of the protocol stack 200. For example, the procedure 800 may be performed between a network entity 802, which may be examples of a CN 106 (e.g., a location server, an LMF, or NWDAF) as described herein, and a UE-side node 804, which may be examples of the UE 104, the UE 206, and/or the UE 604. Note that the UE-side node 804 may refer to a UE (e.g. a target device) or may refer to an OTT server associated with the UE.

In various implementations, the UE-side node 804 may request the network entity 802 for assistance information or configuration information needed to derive/compute the model monitoring metric for one or more AI/ML models used for positioning including direct AI/ML poisoning or assisted AI/ML positioning performed at the UE-side node 804. The steps of the procedure 800 are described as follows:

At step 0, the UE-side node 804 may trigger its performance model monitoring procedure based on its own implementation derived model monitoring metrics to ascertain the performance of the various models (see block 806). The monitoring procedure may be triggered based on variety factors, e.g., evaluating the positioning performance of currently deployed models in order to decide whether to update, switch, activate, and/or deactivate the one or more AI/ML models, e.g., for positioning.

At step 1, the UE-side node 804, may transmit a request message to the network entity 802 for assistance information/data or configuration information needed/required by the UE-side node 804 to compute the one or more model/functionality monitoring metrics (see messaging 808). In some examples, the request message may comprise a LPP message, e.g., a RequestAssistance data message or an AI/ML positioning information/configuration request message.

In some examples, the request message may also additionally include some associated meta-information regarding the type of assistance data and/or configuration information requested, e.g., DL-PRS configuration information, TRP/ARP location information, TRP/Beam information, synchronization information, e.g., real-time difference (RTD) information, LOS/NLOS indicator information, TRP timing error group (TEG) information, integrity information (integrity bounds), validity area information, PRU information including location information and/or PRU measurement information, statistical information, input parameters for the model/functionality metric calculation. The request message may further request the type of performance monitoring to be performed, e.g., model performance monitoring, model drift and degradation performance and/or model operational performance metrics.

At step 2, the network entity 802 determines the necessary assistance data and/or configuration information, which may assist in the model metric calculation based on the received request. Additionally, the network entity 802 transmits a response message with the determined assistance data and/or configuration information (see messaging 810). In some examples, the request message may comprise a LPP message, e.g., a ProvideAssistance data message or an AI/ML positioning information/configuration response message.

At step 3, the UE-side node 804 determines the monitoring metrics for one or more AI/ML models and/or functionalities based at least in part on the assistance data and/or configuration information received from the network entity 802 (see block 812). In some implementations, the monitoring metrics for one or more AI/ML models and/or functionalities may then be translated into high-level information describing the model/functionality monitoring outcomes.

In one implementation, the network entity 802 may indicate the unavailability of the requested assistance data and/or configuration information or the unavailability of the subset of the requested assistance data and/or configuration information. In some examples, the network entity 802 may also transmit an error cause message indicating the unavailability of such assistance data and/or configuration information.

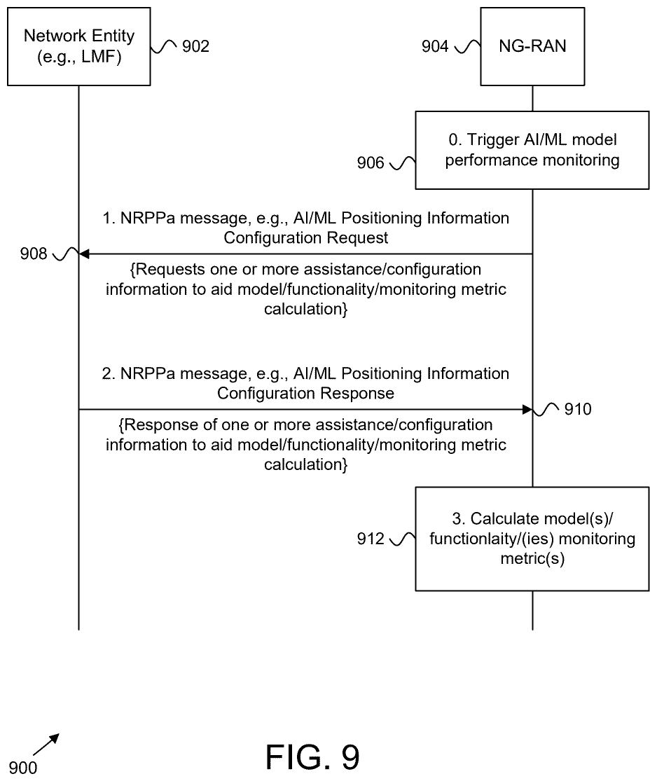

FIG. 9 illustrates an example of a procedure 900 for requesting assistance information or configuration information, in accordance with aspects of the present disclosure. The procedure 900 may implement or be implemented by aspects of the wireless communications system 100, or may implement or be implemented by aspects of the protocol stack 200. For example, the procedure 900 may be performed between a network entity 902, which may be examples of a CN 106 (e.g., a location server, an LMF, or NWDAF) as described herein, and a NG-RAN node 904, which may be examples of the NE 102, the RAN node 208, and/or the NG-RAN node 704.

In various implementations, the NG-RAN node 904 may request the network entity 902 for assistance information or configuration information needed to derive/compute the model monitoring metric for one or more AI/ML models used for positioning including direct AI/ML poisoning or assisted AI/ML positioning performed at the NG-RAN node 904. The steps of the procedure 900 are described as follows:

At step 0, the NG-RAN node 904 may trigger its performance model monitoring procedure based on its own implementation derived model monitoring metrics to ascertain the performance of the various models (see block 906). The monitoring procedure may be triggered based on variety factors, e.g., evaluating the positioning performance of currently deployed models in order to decide whether to update, switch, activate, and/or deactivate the one or more AI/ML models, e.g., for positioning.

At step 1, the NG-RAN node 904, may transmit a request message to the network entity 902 for assistance information/data or configuration information needed/required by the NG-RAN node 904 to compute the one or more model/functionality monitoring metrics (see messaging 908). In some examples, the request message may comprise a NRPPa message, e.g. an AI/ML positioning information/configuration request message.

In some examples, the request message may also additionally include some associated meta-information regarding the type of assistance data and/or configuration information requested, e.g., DL-PRS configuration information, TRP/ARP location information, TRP/Beam information, synchronization information, e.g., RTD information, LOS/NLOS indicator information, TRP TEG information, integrity information (e.g. integrity bounds), validity area information, PRU information including location information and/or PRU measurement information, statistical information, input parameters for the model/functionality metric calculation. The request message may further request the type of performance monitoring to be performed, e.g., model performance monitoring, model drift and degradation performance and/or model operational performance metrics.

At step 2, the network entity 902 determines the necessary assistance data and/or configuration information, which may assist in the model metric calculation based on the received request. Additionally, the network entity 902 transmits a response message with the determined assistance data and/or configuration information (see messaging 910). In some examples, the request message may comprise a NRPPa message, e.g. an AI/ML positioning information/configuration response message.

At step 3, the NG-RAN node 904 determines the monitoring metrics for one or more AI/ML models and/or functionalities based at least in part on the assistance data and/or configuration information received from the network entity 902 (see block 912). In some implementations, the monitoring metrics for one or more AI/ML models and/or functionalities may then be translated into high-level information describing the model/functionality monitoring outcomes.

In one implementation, the network entity 902 may indicate the unavailability of the requested assistance data and/or configuration information or the unavailability of the subset of the requested assistance data and/or configuration information. In some examples, the network entity 902 may also transmit an error cause message indicating the unavailability of such assistance data and/or configuration information.

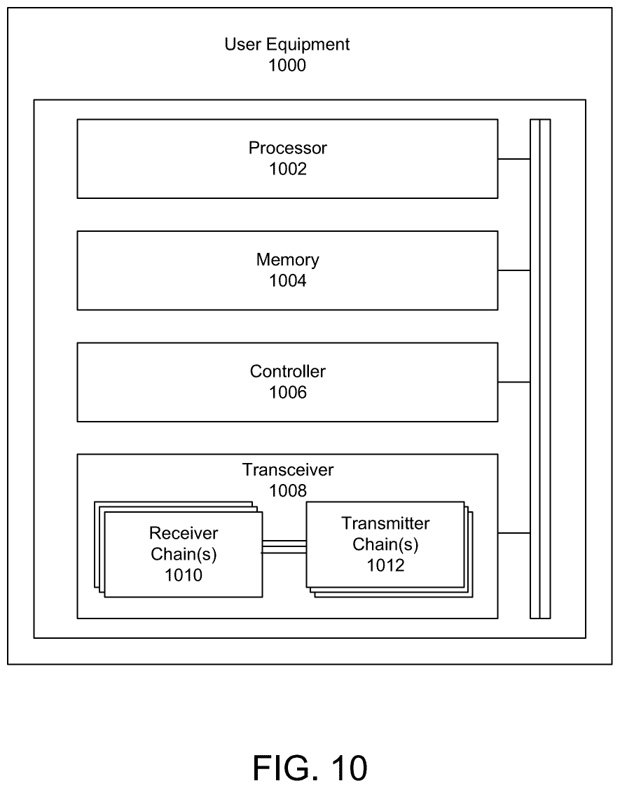

FIG. 10 illustrates an example of a UE 1000 in accordance with aspects of the present disclosure. The UE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a central processing unit (CPU), an ASIC, a field programmable gate array (FPGA), or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the UE 1000 to perform various functions of the present disclosure.

The memory 1004 may include volatile or non-volatile memory. The memory 1004 may store computer-readable, computer-executable code including instructions that, when executed by the processor 1002, cause the UE 1000 to perform various functions described herein. The code may be stored in a non-transitory computer-readable medium such the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the UE 1000 to perform various functions (e.g., operations, signaling) described herein (e.g., executing, by the processor 1002, instructions stored in the memory 1004). In some implementations, the processor 1002 may include multiple processors and the memory 1004 may include multiple memories. One or more of the multiple processors may be coupled with one or more of the multiple memories, which may be individually or collectively, configured to perform various functions (e.g., operations, signaling) of the UE 1000 as described herein.

The processor 1002 coupled with the memory 1004 may be configured to, capable of, or operable to cause the UE 1000 to receive a request message for reporting one or more model performance monitoring results, where the request message comprises a reporting configuration including a set of parameters identifying one or more performance indicators associated with one or more AI/ML models; determine one or more model performance metrics associated with the one or more AI/ML models; convert the one or more performance model metrics to a set of model performance monitoring results based at least in part on the reporting configuration; and transmit a response message comprising the set of set of model performance monitoring results.

In some implementations, the set of parameters further identifies the one or more AI/ML models or one or more AI/ML functionalities. In some implementations, the response message comprises an indication that a model performance monitoring result is unavailable for an AI/ML model or AI/ML functionality.

In some implementations, the processor 1002 coupled with the memory 1004 may be configured to, capable of, or operable to cause the UE 1000 to: A) transmit a second request message for assistance data related to the computation of metrics for one or more AI/ML models or AI/ML functionalities; B) receive a second response message comprising a monitoring configuration; and C) determine the one or more model performance metrics based at least in part on the monitoring configuration. In certain implementations, the second response message comprises an indication that the assistance data for computing the metrics for an AI/ML model or AI/ML functionality is unavailable.

In some implementations, the set of parameters comprises model-specific parameters for positioning model performance, where the one or more model performance monitoring results are based on the model-specific parameters and comprise one or more of: A) a hard-decision indicator of a horizontal positioning accuracy, B) a soft decision/performance indicator of the horizontal positioning accuracy, C) a hard-decision indicator of a vertical positioning accuracy, or D) a soft decision/performance indicator of the vertical positioning accuracy, or E) a combination thereof.

In some implementations, the set of parameters further identifies one or more types of performance monitoring, time domain reporting criteria, or a prioritization of requested performance monitoring results, or a combination thereof.

In some implementations, the reporting configuration comprises a request for statistical information regarding the reliability of the model performance monitoring (e.g., the reliability of one or more model performance metrics). In such implementations, the response message may include the statistical information, such as model monitoring statistics regarding the accuracy, precision, recall, false alarm, etc. of the model performance monitoring.

In some implementations, the request message and the response message comprise LPP messages, SUPL messages, SS messages, or LCS-UPP protocol messages, or a combination thereof.

The controller 1006 may manage input and output signals for the UE 1000. The controller 1006 may also manage peripherals not integrated into the UE 1000. In some implementations, the controller 1006 may utilize an operating system (OS) such as iOS®, ANDROID®, WINDOWS®, or other operating systems. In some implementations, the controller 1006 may be implemented as part of the processor 1002.

In some implementations, the UE 1000 may include at least one transceiver 1008. In some other implementations, the UE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas for receiving the signal over the air or wireless medium. The receiver chain 1010 may include at least one amplifier (e.g., a low-noise amplifier (LNA)) configured to amplify the received signal. The receiver chain 1010 may include at least one demodulator configured to demodulate the received signal and obtain the transmitted data by reversing the modulation technique applied during transmission of the signal. The receiver chain 1010 may include at least one decoder for decoding/processing the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

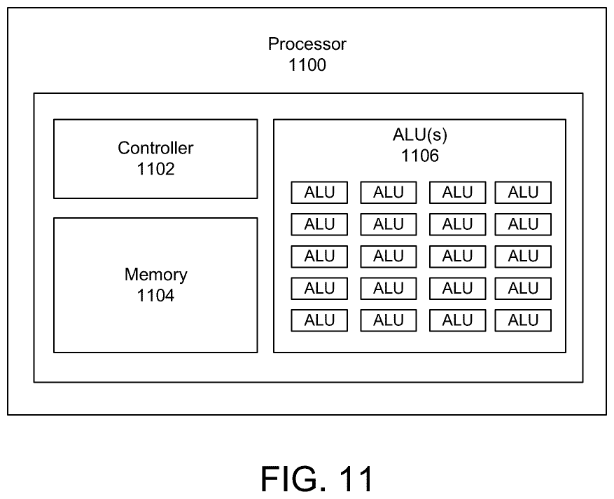

FIG. 11 illustrates an example of a processor 1100 in accordance with aspects of the present disclosure. The processor 1100 may be an example of a processor configured to perform various operations in accordance with examples as described herein. The processor 1100 may include a controller 1102 configured to perform various operations in accordance with examples as described herein. The processor 1100 may optionally include at least one memory 1104, which may be, for example, an L1, or L2, or L3 cache. Additionally, or alternatively, the processor 1100 may optionally include one or more arithmetic-logic units (ALUs) 1106. One or more of these components may be in electronic communication or otherwise coupled (e.g., operatively, communicatively, functionally, electronically, electrically) via one or more interfaces (e.g., buses).

The processor 1100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1102 may be configured to manage and coordinate various operations (e.g., signaling, receiving, obtaining, retrieving, transmitting, outputting, forwarding, storing, determining, identifying, accessing, writing, reading) of the processor 1100 to cause the processor 1100 to support various operations in accordance with examples as described herein. For example, the controller 1102 may operate as a control unit of the processor 1100, generating control signals that manage the operation of various components of the processor 1100. These control signals include enabling or disabling functional units, selecting data paths, initiating memory access, and coordinating timing of operations.

The controller 1102 may be configured to fetch (e.g., obtain, retrieve, receive) instructions from the memory 1104 and determine subsequent instruction(s) to be executed to cause the processor 1100 to support various operations in accordance with examples as described herein. The controller 1102 may be configured to track memory address of instructions associated with the memory 1104. The controller 1102 may be configured to decode instructions to determine the operation to be performed and the operands involved. For example, the controller 1102 may be configured to interpret the instruction and determine control signals to be output to other components of the processor 1100 to cause the processor 1100 to support various operations in accordance with examples as described herein. Additionally, or alternatively, the controller 1102 may be configured to manage flow of data within the processor 1100. The controller 1102 may be configured to control transfer of data between registers, arithmetic logic units (ALUs), and other functional units of the processor 1100.

The memory 1104 may include one or more caches (e.g., memory local to or included in the processor 1100 or other memory, such RAM, ROM, DRAM, SDRAM, SRAM, MRAM, flash memory, etc. In some implementations, the memory 1104 may reside within or on a processor chipset (e.g., local to the processor 1100). In some other implementations, the memory 1104 may reside external to the processor chipset (e.g., remote to the processor 1100).

The memory 1104 may store computer-readable, computer-executable code including instructions that, when executed by the processor 1100, cause the processor 1100 to perform various functions described herein. The code may be stored in a non-transitory computer-readable medium such as system memory or another type of memory. The controller 1102 and/or the processor 1100 may be configured to execute computer-readable instructions stored in the memory 1104 to cause the processor 1100 to perform various functions. For example, the processor 1100 and/or the controller 1102 may be coupled with or to the memory 1104, the processor 1100, the controller 1102, and the memory 1104 may be configured to perform various functions described herein. In some examples, the processor 1100 may include multiple processors and the memory 1104 may include multiple memories. One or more of the multiple processors may be coupled with one or more of the multiple memories, which may, individually or collectively, be configured to perform various functions herein.

The one or more ALUs 1106 may be configured to support various operations in accordance with examples as described herein. In some implementations, the one or more ALUs 1106 may reside within or on a processor chipset (e.g., the processor 1100). In some other implementations, the one or more ALUs 1106 may reside external to the processor chipset (e.g., the processor 1100). One or more ALUs 1106 may perform one or more computations such as addition, subtraction, multiplication, and division on data. For example, one or more ALUs 1106 may receive input operands and an operation code, which determines an operation to be executed. One or more ALUs 1106 be configured with a variety of logical and arithmetic circuits, including adders, subtractors, shifters, and logic gates, to process and manipulate the data according to the operation. Additionally, or alternatively, the one or more ALUs 1106 may support logical operations such as AND, OR, exclusive-OR (XOR), not-OR (NOR), and not-AND (NAND), enabling the one or more ALUs 1106 to handle conditional operations, comparisons, and bitwise operations.

In some implementations, the processor 1100 may support various functions (e.g., operations, signaling) of a UE, in accordance with examples as disclosed herein. For example, the controller 1102 coupled with the memory 1104 may be configured to, capable of, or operable to cause the processor 1100 to receive a request message for reporting one or more model performance monitoring results, where the request message comprises a reporting configuration including a set of parameters identifying one or more performance indicators associated with one or more AI/ML models; determine one or more model performance metrics associated with the one or more AI/ML models; convert the one or more performance model metrics to a set of model performance monitoring results based at least in part on the reporting configuration; and transmit a response message comprising the set of set of model performance monitoring results. Additionally, the controller 1102 coupled with the memory 1104 may be configured to, capable of, or operable to cause the processor 1100 to perform one or more functions (e.g., operations, signaling) of the UE as described herein.

In certain implementations, the processor 1100 may support various functions (e.g., operations, signaling) of a RAN node (e.g., base station or gNB), in accordance with examples as disclosed herein. For example, the controller 1102 coupled with the memory 1104 may be configured to, capable of, or operable to cause the processor 1100 to receive a request message for reporting one or more model performance monitoring results, where the request message comprises a reporting configuration including a set of parameters identifying one or more performance indicators associated with one or more AI/ML models; determine one or more model performance metrics associated with the one or more AI/ML models; convert the one or more performance model metrics to a set of model performance monitoring results based at least in part on the reporting configuration; and transmit a response message comprising the set of set of model performance monitoring results. Additionally, the controller 1102 coupled with the memory 1104 may be configured to, capable of, or operable to cause the processor 1100 to perform one or more functions (e.g., operations, signaling) of the RAN node as described herein.

Additionally, or alternatively, in some other implementations, the processor 1100 may support various functions (e.g., operations, signaling) of a network node for performance monitoring (e.g., LMF, NWDAF), in accordance with examples as disclosed herein. For example, the controller 1102 coupled with the memory 1104 may be configured to, capable of, or operable to cause the processor 1100 to determine a reporting configuration for model performance monitoring, where the reporting configuration comprises a set of parameters identifying one or more performance indicators associated with one or more AI/ML models; transmit a request message for one or more model performance monitoring results, where the request message comprises the reporting configuration; and receive a response message comprising one or more model performance monitoring results. Additionally, the controller 1102 coupled with the memory 1104 may be configured to, capable of, or operable to cause the processor 1100 to perform one or more functions (e.g., operations, signaling) of the network node for performance monitoring as described herein.

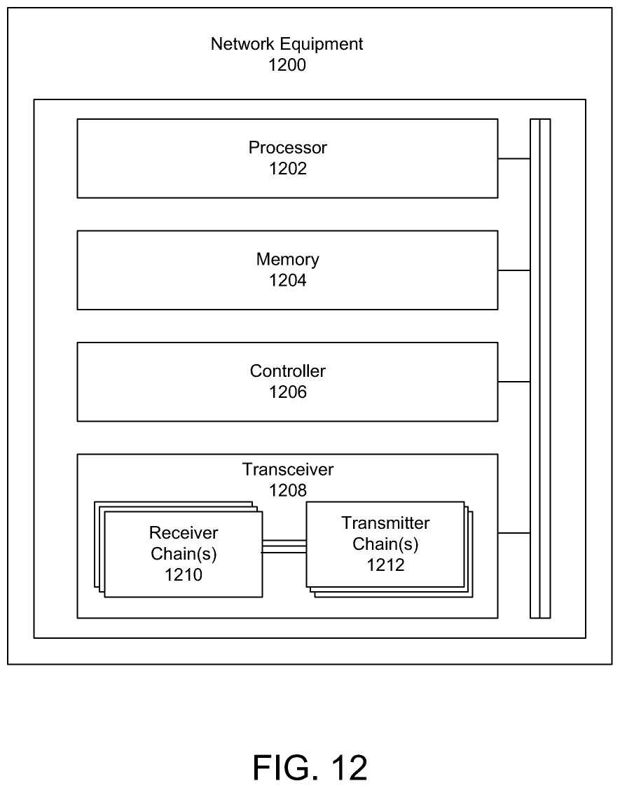

FIG. 12 illustrates an example of a NE 1200 in accordance with aspects of the present disclosure. The NE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the NE 1200 to perform various functions of the present disclosure.

The memory 1204 may include volatile or non-volatile memory. The memory 1204 may store computer-readable, computer-executable code including instructions when executed by the processor 1202 cause the NE 1200 to perform various functions described herein. The code may be stored in a non-transitory computer-readable medium such the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the NE 1200 to perform various functions (e.g., operations, signaling) described herein (e.g., executing, by the processor 1202, instructions stored in the memory 1204). In some implementations, the processor 1202 may include multiple processors and the memory 1204 may include multiple memories. One or more of the multiple processors may be coupled with one or more of the multiple memories, which may be individually or collectively, configured to perform various functions (e.g., operations, signaling) of the NE 1200 as described herein.

The processor 1202 coupled with the memory 1204 may be configured to, capable of, or operable to cause the NE 1200 to receive a request message for reporting one or more model performance monitoring results, where the request message comprises a reporting configuration including a set of parameters identifying one or more performance indicators associated with one or more AI/ML models; determine one or more model performance metrics associated with the one or more AI/ML models; convert the one or more performance model metrics to a set of model performance monitoring results based at least in part on the reporting configuration; and transmit a response message comprising the set of set of model performance monitoring results.

In some implementations, the set of parameters further identifies the one or more AI/ML models or one or more AI/ML functionalities. In some implementations, the response message comprises an indication that a model performance monitoring result is unavailable for an AI/ML model or AI/ML functionality.

In some implementations, the processor 1202 coupled with the memory 1204 may be configured to, capable of, or operable to cause the NE 1200 to: A) transmit a second request message for assistance data related to the computation of metrics for one or more AI/ML models or AI/ML functionalities; B) receive a second response message comprising a monitoring configuration; and C) determine the one or more model performance metrics based at least in part on the monitoring configuration. In certain implementations, the second response message comprises an indication that the assistance data for computing the metrics for an AI/ML model or AI/ML functionality is unavailable.

In some implementations, the set of parameters comprises model-specific parameters for positioning model performance, where the one or more model performance monitoring results are based on the model-specific parameters and comprise one or more of: A) a hard-decision indicator of a horizontal positioning accuracy, B) a soft decision/performance indicator of the horizontal positioning accuracy, C) a hard-decision indicator of a vertical positioning accuracy, or D) a soft decision/performance indicator of the vertical positioning accuracy, or E) a combination thereof.

In some implementations, the set of parameters further identifies one or more types of performance monitoring, time domain reporting criteria, or a prioritization of requested performance monitoring results, or a combination thereof.

In some implementations, the reporting configuration comprises a request for statistical information regarding a reliability of the model performance monitoring. In such implementations, the response message may include the statistical information, such as model monitoring statistics regarding the accuracy, precision, recall, false alarm, etc. of the model performance monitoring.

In some other implementations, the request message and the response message comprise NRPPa messages, or network function interface messages, or a combination thereof.

Additionally, or alternatively, in some other implementations, the processor 1202 and the memory 1204 coupled with the processor 1202 may be configured to cause the NE 1200 to perform various functions (e.g., operations, signaling) of a LMF, NWDAF, or core network function, in accordance with examples as disclosed herein. For example, the controller 1102 coupled with the memory 1104 may be configured to, capable of, or operable to cause the processor 1100 to determine a reporting configuration for model performance monitoring, where the reporting configuration comprises a set of parameters identifying one or more performance indicators associated with one or more AI/ML models; transmit a request message for one or more model performance monitoring results, where the request message comprises the reporting configuration; and receive a response message comprising one or more model performance monitoring results.

In some implementations, the set of parameters further identifies the one or more AI/ML models or one or more AI/ML functionalities. In some implementations, the response message comprises an indication that a model performance monitoring result is unavailable for an AI/ML model or AI/ML functionality.

In some implementations, the set of parameters comprises model-specific parameters for positioning model performance, where the one or more model performance monitoring results are based on the model-specific parameters and comprise one or more of: A) a hard-decision indicator of a horizontal positioning accuracy, B) a soft performance indicator of the horizontal positioning accuracy, C) a hard-decision indicator of a vertical positioning accuracy, or D) a soft performance indicator of the vertical positioning accuracy, E) explicit horizontal/vertical positioning accuracy or F) a combination thereof.

In some implementations, the set of parameters further identifies one or more types of performance monitoring, time domain reporting criteria, or a prioritization of requested performance monitoring results, or a combination thereof.

In some implementations, the reporting configuration comprises a request for statistical information regarding a reliability of the model performance monitoring. In such implementations, the response message may include the statistical information, such as model monitoring statistics regarding the accuracy, precision, recall, false alarm, etc. of the model performance monitoring.

In some implementations, the request message and the response message comprise LPP messages, SUPL messages, SS messages, or LCS-UPP protocol messages, or a combination thereof. In some other implementations, the request message and the response message comprise NRPPa messages, or network function interface messages, or a combination thereof.

In some implementations, the at least one processor is configured to cause the wireless communication apparatus to: A) receive a second request message for assistance data related to the computation of metrics for one or more AI/ML models or AI/ML functionalities; B) determine a monitoring configuration in response to the second request message; and C) transmit a second response message comprising a monitoring configuration. In certain implementations, the second response message comprises an indication that the assistance data for computing the metrics for the one or more AI/ML models or AI/ML functionalities is unavailable.

The controller 1206 may manage input and output signals for the NE 1200. The controller 1206 may also manage peripherals not integrated into the NE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the NE 1200 may include at least one transceiver 1208. In some other implementations, the NE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas for receiving the signal over the air or wireless medium. The receiver chain 1210 may include at least one amplifier (e.g., a low-noise amplifier (LNA)) configured to amplify the received signal. The receiver chain 1210 may include at least one demodulator configured to demodulate the received signal and obtain the transmitted data by reversing the modulation technique applied during transmission of the signal. The receiver chain 1210 may include at least one decoder for decoding/processing the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

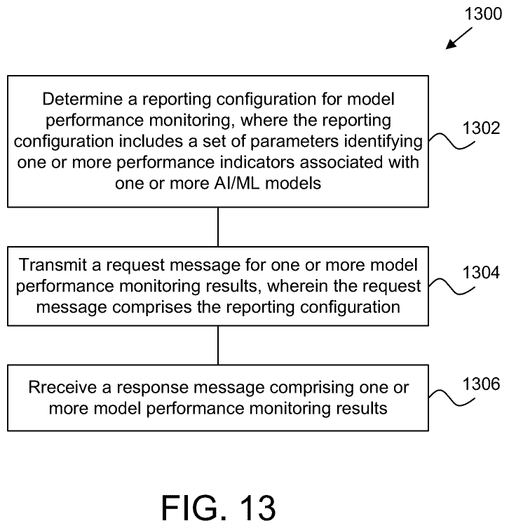

FIG. 13 illustrates a flowchart of a method 1300 in accordance with aspects of the present disclosure. The operations of the method 1300 may be implemented by a CN node as described herein. Alternatively, the method 1300 may be implemented by a NE as described herein. In some implementations, the CN node and/or NE may execute a set of instructions to control the function elements of the CN node and/or NE to perform the described functions.

At step 1302, the method 1300 may include determining a reporting configuration for model performance monitoring, where the reporting configuration comprises a set of parameters identifying one or more performance indicators associated with one or more AI/ML models. The operations of step 1302 may be performed in accordance with examples as described herein. In some implementations, aspects of the operations of step 1302 may be performed by a NE, as described with reference to FIG. 12.

At step 1304, the method 1300 may include transmitting a request message for one or more model performance monitoring results, where the request message comprises the reporting configuration. The operations of step 1304 may be performed in accordance with examples as described herein. In some implementations, aspects of the operations of step 1304 may be performed by a NE, as described with reference to FIG. 12.

At step 1306, the method 1300 may include receiving a response message comprising one or more model performance monitoring results. The operations of step 1306 may be performed in accordance with examples as described herein. In some implementations, aspects of the operations of step 1306 may be performed by a NE, as described with reference to FIG. 12.

It should be noted that the method 1300 described herein describes one possible implementation, and that the operations and the steps may be rearranged or otherwise modified and that other implementations are possible.

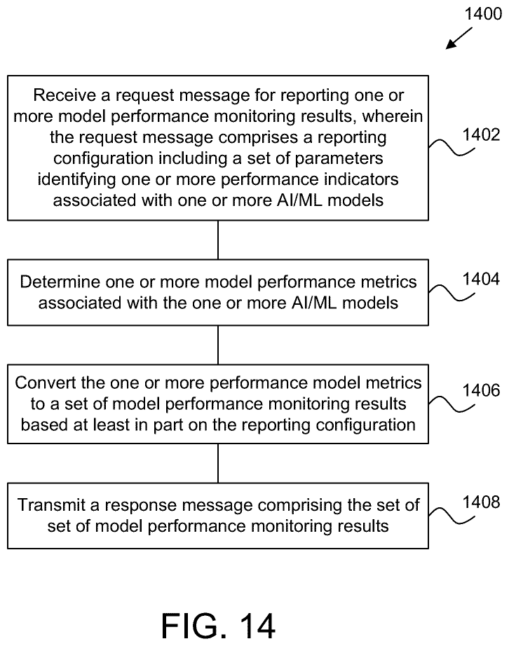

FIG. 14 illustrates a flowchart of a method 1400 in accordance with aspects of the present disclosure. The operations of the method 1400 may be implemented by a UE as described herein. Alternatively, the operations of the method 1400 may be implemented by a NE as described herein. In some implementations, the UE and/or NE may execute a set of instructions to control the function elements of the UE and/or NE to perform the described functions.

At step 1402, the method 1400 may include receiving a request message for reporting one or more model performance monitoring results, where the request message comprises a reporting configuration including a set of parameters identifying one or more performance indicators associated with one or more AI/ML models. The operations of step 1402 may be performed in accordance with examples as described herein. In some implementations, aspects of the operations of step 1402 may be performed by a UE, as described with reference to FIG. 10. In some other implementations, aspects of the operations of step 1402 may be performed by a NE, as described with reference to FIG. 12.

At step 1404, the method 1400 may include determining one or more model performance metrics associated with the one or more AI/ML models. The operations of step 1404 may be performed in accordance with examples as described herein. In some implementations, aspects of the operations of step 1404 may be performed by a UE, as described with reference to FIG. 10. In some other implementations, aspects of the operations of step 1404 may be performed by a NE, as described with reference to FIG. 12.

At step 1406, the method 1400 may include converting the one or more performance model metrics to a set of model performance monitoring results based at least in part on the reporting configuration. The operations of step 1406 may be performed in accordance with examples as described herein. In some implementations, aspects of the operations of step 1406 may be performed by a UE, as described with reference to FIG. 10. In some other implementations, aspects of the operations of step 1406 may be performed by a NE, as described with reference to FIG. 12.

At step 1408, the method 1400 may include transmitting a response message comprising the set of set of model performance monitoring results. The operations of step 1408 may be performed in accordance with examples as described herein. In some implementations, aspects of the operations of step 1408 may be performed by a UE, as described with reference to FIG. 10. In some other implementations, aspects of the operations of step 1408 may be performed by a NE, as described with reference to FIG. 12.

It should be noted that the method 1400 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network apparatus comprising:
at least one memory; and
at least one processor coupled with the at least one memory and configured to cause the network apparatus to:
determine a reporting configuration for model performance monitoring, wherein the reporting configuration comprises a set of parameters identifying one or more performance indicators associated with one or more artificial intelligence or machine learning (AI/ML) models;
transmit a request message for one or more model performance monitoring results, wherein the request message comprises the reporting configuration; and
receive a response message comprising one or more model performance monitoring results.

2. The network apparatus of claim 1, wherein the response message comprises an indication that a model performance monitoring result is unavailable for an AI/ML model or AI/ML functionality.

3. The network apparatus of claim 1, wherein the set of parameters further identifies the one or more AI/ML models or one or more AI/ML functionalities.

4. The network apparatus of claim 1, wherein the set of parameters comprises model-specific parameters for positioning model performance, wherein the one or more model performance monitoring results are based on the model-specific parameters and comprise one or more of:
a hard-decision indicator of a horizontal positioning accuracy,
a soft performance indicator of the horizontal positioning accuracy,
a hard-decision indicator of a vertical positioning accuracy,
a soft performance indicator of the vertical positioning accuracy,
an explicit horizontal positioning accuracy, or
an explicit vertical positioning accuracy.

5. The network apparatus of claim 1, wherein the set of parameters further identifies one or more types of performance monitoring, time domain reporting criteria, or a prioritization of requested performance monitoring results, or a combination thereof.

6. The network apparatus of claim 1, wherein the reporting configuration comprises a request for statistical information regarding a reliability of the model performance monitoring.

7. The network apparatus of claim 1, wherein the request message and the response message comprise long-term evolution (LTE) positioning protocol (LPP) messages, secure user plane (SUPL) messages, supplementary service (SS) messages, or location service user plane positioning (LCS-UPP) protocol messages, or a combination thereof.

8. The network apparatus of claim 1, wherein the request message and the response message comprise new radio (NR) positioning protocol annex (NRPPa) messages, or network function interface messages, or a combination thereof.

9. The network apparatus of claim 1, wherein the at least one processor is configured to cause the network apparatus to:
receive a second request message for assistance information related to a computation of metrics for one or more AI/ML models or AI/ML functionalities;
determine a monitoring configuration in response to the second request message; and
transmit a second response message comprising the monitoring configuration.

10. A method performed by a network entity, the method comprising:
determining a reporting configuration for model performance monitoring, wherein the reporting configuration comprises a set of parameters identifying one or more performance indicators associated with one or more artificial intelligence or machine learning (AI/ML) models;
transmitting a request message for reporting one or more model performance monitoring results, wherein the request message comprises the reporting configuration; and
receiving a response message comprising one or more model performance monitoring results.

11. A wireless communication apparatus, comprising:
at least one memory; and
at least one processor coupled with the at least one memory and configured to cause the wireless communication apparatus to:
receive a request message for reporting one or more model performance monitoring results, wherein the request message comprises a reporting configuration including a set of parameters identifying one or more performance indicators associated with one or more artificial intelligence or machine learning (AI/ML) models;
determine one or more model performance metrics associated with the one or more AI/ML models;
convert the one or more performance model metrics to a set of model performance monitoring results based at least in part on the reporting configuration; and
transmit a response message comprising the set of set of model performance monitoring results.

12. The apparatus of claim 11, wherein the at least one processor is configured to cause the wireless communication apparatus to:
transmit a request message for assistance data related to a computation of metrics for the one or more AI/ML models or one or more AI/ML functionalities;
receive a second response message comprising a monitoring configuration; and
determine the one or more model performance metrics based at least in part on the monitoring configuration.

13. The apparatus of claim 12, wherein the response message comprises an indication that the assistance data for computing the metrics for an AI/ML model or AI/ML functionality is unavailable.

14. The apparatus of claim 11, wherein the response message comprises an indication that a model performance monitoring result is unavailable for an AI/ML model or AI/ML functionality.

15. The apparatus of claim 11, wherein the set of parameters further identifies the one or more AI/ML models or one or more AI/ML functionalities.

16. The apparatus of claim 11, wherein the set of parameters further identifies one or more types of performance monitoring, time domain reporting criteria, or a prioritization of requested performance monitoring results, or a combination thereof.

17. The apparatus of claim 11, wherein the reporting configuration comprises a request for statistical information regarding a reliability of the model performance monitoring.

18. The apparatus of claim 11, wherein the wireless communication apparatus comprises a user equipment (UE), and wherein request message and the response message comprise long-term evolution (LTE) positioning protocol (LPP) messages, secure user plane (SUPL) messages, supplementary service (SS) messages, or location service user plane positioning (LCS-UPP) protocol messages, or a combination thereof.

19. The apparatus of claim 11, wherein the wireless communication apparatus comprises a base station, and wherein the request message and the response message comprise new radio (NR) positioning protocol annex (NRPPa) messages, or network function interface messages, or a combination thereof.

20. A method performed by a wireless communication node, the method comprising:
receiving a request message for reporting one or more model performance monitoring results, wherein the request message comprises a reporting configuration including a set of parameters identifying one or more performance indicators associated with one or more artificial intelligence or machine learning (AI/ML) models;
determining one or more model performance metrics associated with the one or more AI/ML models;
converting the one or more performance model metrics to a set of model performance monitoring results based at least in part on the reporting configuration; and
transmitting a response message comprising the set of set of model performance monitoring results.
